(19) United States
(12) Patent Application Publication
(10) Pub. No.: US 2022/0299208 A1
(43) Pub. Date: Sep. 22, 2022

(54) READY TO ASSEMBLE SIMULATED FIREPLACE INSERT KIT

(71) Applicant: Living Style (B.V.I.) Limited, Tortola (VG)

(72) Inventors: Paul Jones, San Diego, CA (US); Willard Lassen, San Diego, CA (US)

(73) Assignee: Living Style (B.V.I.) Limited, Tortola (VG)

(21) Appl. No.: 17/694,403

(22) Filed: Mar. 14, 2022

Related U.S. Application Data
(60) Provisional application No. 63/162,715, filed on Mar. 18, 2021.
(60) Provisional application No. 63/181,693, filed on Apr. 29, 2021.

(51) Int. Cl. F24C 7/00; F24C 15/04; F24C 15/06; F24C 15/08

(52) U.S. Cl. CPC F24C 7/004; F24C 15/04; F24C 15/06; F24C 15/08

(57) ABSTRACT

The present disclosure provides a novel ready to assemble simulated fireplace insert kit which can be combined with a pre-built furniture piece, or a ready to assemble furniture piece to provide a unique solution in the ready to assemble furniture product category. The ready to assemble simulated fireplace insert is broken down into individual components that can more easily be packed and shipped in a flat format and assembled by the end user. In some embodiments, certain components may be shared across different width insert assemblies to reduce costs.

### CROSS-REFERENCE TO RELATED APPLICATIONS

This application is a non-provisional filing of, and claims the benefit of U.S. Provisional Application No. 63/162,715, filed Mar. 18, 2021, and U.S. Provisional Application No. 63/181,693, filed Apr. 29, 2021, the entire contents of which are both incorporated herein in their entirety.

### BACKGROUND

### 1. Technical Field

The present disclosure relates generally to ready to assemble furniture kits and more particularly to a ready to assemble simulated fireplace insert kit which may in some embodiments be combined with a ready to assemble furniture kit to create a combination kit for end user assembly.

### 2. Background of the Related Art

Simulated fireplace inserts are known in the industry and have become extremely popular over the last 5-10 years as technology has improved to provide more realistic visual simulated flame and fire effects. While they often also provide a heating unit, they are primarily purchased for the aesthetic appearance of a fire. Both the heating unit and the visual projection components of the simulated fireplace unit require some amount of width and depth for both function and aesthetic appearance. In this regard, the fireplace inserts are typically manufactured as a sealed or welded box unit and may be shipped with, or without an accompany furniture piece or console into which the insert may be received for display and use.

### SUMMARY OF THE DISCLOSURE

As simulated fireplace products have worked their way into higher volume furniture categories, the closed box construction of the fireplace insert has presented several issues for manufacturers and retailers trying to reduce delivery costs. Most notably, the finished box construction of the insert creates a considerable amount of empty volume within the insert thereby increasing the overall shipping size of the insert and the overall cost of delivery per unit.

The present disclosure provides in one respect, a novel ready to assemble simulated fireplace insert kit which may be provided as a stand-alone kit and/or combined with a ready to assemble furniture console kit to provide a unique solution in the ready to assemble furniture product category. The ready to assemble simulated fireplace insert is broken down into individual components that can more easily be packed and shipped in a flat format thus significantly reducing shipping cost and storage space.

The present disclosure also provides a method of assembling a complete simulated fireplace console wherein the simulated insert is provided as a kit and the furniture assembly is also provided as a kit, together or separately, wherein the two kits are assembled separately, and the insert kit is then assembled with the furniture kit.

In some embodiments, the simulated fireplace insert kit provides a stand-alone insert where a single insert assembly kit is provided for assembly by the user prior to combination with a separate furniture piece.

In some embodiments, the simulated fireplace insert kit provides an insert kit with a furniture kit where both the insert assembly kit and the furniture kit are provided in combination for assembly by the user.

In some embodiments, certain high-cost components may be universal to all insert kit assemblies and may be shared across different width insert assemblies to reduce volume manufacturing costs.

In some embodiments, certain parts of the firebox walls are provided as part of the insert kit, in other embodiments certain parts of the firebox walls are provided as part of the furniture assembly and in other embodiments, certain parts of the firebox walls are split between the insert kit and the furniture assembly kit.

In accordance with the exemplary embodiments herein described the present disclosure provides for the following objectives:

1. A ready to assemble simulated fireplace insert kit comprising:

a firebox panel having a rear imaging screen portion and a forwardly extending portion;

a foundation having a front, a top, opposing left and right sides, and a rear;

said firebox panel having a lower peripheral edge removably secured to said foundation,

first and second upright structural supports each having a lower end removably secured to said foundation adjacent to said front,

said forwardly extending panel portion of said firebox panel engaging said uprights structural supports whereby said foundation and said upright structural supports transfer structural rigidity to said firebox panel; and

a simulated firebed assembly removably received on the foundation.

2. The ready to assemble simulated fireplace insert kit of claim 1,

wherein each of said upright supports has a rearwardly extending firebox panel attachment structure,

said forwardly extending portion of said firebox panel having a respective forward edge portion removably secured to said rearwardly extending firebox panel attachment structures of said upright structural supports.

3. The ready to assemble simulated fireplace insert kit of claim 1,
wherein said forwardly extending panel portion comprises left and right side panel portions extending forwardly from side edges of said rear imaging screen portion.

4. The ready to assemble simulated fireplace insert kit of claim 3,

wherein said rearwardly extending firebox panel attachment structures comprise a planar flange extending along at least a portion of said upright supports.

5. The ready to assemble simulated fireplace insert kit of claim 3, wherein said rearwardly extending firebox panel attachment structures comprise a channel extending along at least a portion of said upright supports.

6. The ready to assemble simulated fireplace insert kit of claim 3,

wherein said left and right side panel portions of said firebox panel each have a lower peripheral edge removably secured to said foundation.

7. The ready to assemble simulated fireplace insert kit of claim 2,

wherein said forwardly extending panel portion comprises a top panel portion extending forwardly from a top edge of said rear imaging screen portion

8. The ready to assemble simulated fireplace insert kit of claim 7,

wherein said rearwardly extending firebox panel attachment structures comprise a shoulder extending rearwardly adjacent an upper end of said upright supports.

9. The ready to assemble simulated fireplace insert kit of claim 1,

wherein said forwardly extending panel portion comprises a top panel portion extending forwardly from a top edge of said rear imaging screen portion,

said kit further comprising a firebox panel edge support having a rearwardly extending support structure secured to a forward edge of said top panel portion,

10. The ready to assemble simulated fireplace insert kit of claim 9,

wherein said firebox panel edge support further includes a downwardly extending portion engaging said upright structural supports.

11. The ready to assemble simulated fireplace insert kit of claim 1,

wherein said kit further comprises a heater unit located within the foundation.

12. The ready to assemble simulated fireplace insert kit of claim 1,

wherein said kit further comprises a decorative face frame secured to the front of the foundation.

13. The ready to assemble simulated fireplace insert kit of claim 1,

wherein said kit further comprises a transparent viewing panel removably received and supported at the front of the foundation between said first and second upright supports.

14. The ready to assemble simulated fireplace insert kit of claim 13,

wherein each of said upright structural supports each has an inwardly extending viewing panel attachment structure,

said transparent viewing panel having opposing side edges removably received and coupled to said viewing panel attachment structures.

15. The ready to assemble simulated fireplace insert kit of claim 14,

wherein said transparent viewing panel comprises glass and said viewing panel attachment structures comprise inwardly extending channels.

16. The ready to assemble simulated fireplace insert kit of claim 1,

wherein said kit further comprises a mesh screen panel removably received and supported at the front of the foundation between said left and right upright supports.

17. The ready to assemble simulated fireplace insert kit of claim 1,

wherein said kit further comprises a horizontal structural support extending between upper ends of said first and second upright structural supports.

18. The ready to assemble simulated fireplace insert kit of claim 17,

wherein said horizontal structural support comprises a structural connector removably secured between respective upper ends of said first and second upright structural supports.

19. The ready to assemble simulated fireplace insert kit of claim 2,

wherein said kit further comprises a horizontal structural support extending between upper ends of said first and second upright structural supports.

20. The ready to assemble simulated fireplace insert kit of claim 19,

wherein said horizontal structural support comprises a structural connector removably secured between respective upper ends of said first and second upright structural supports.

21. The ready to assemble simulated fireplace insert kit of claim 3,

wherein said kit further comprises a horizontal structural support extending between upper ends of said first and second upright structural supports.

22. The ready to assemble simulated fireplace insert kit of claim 21,

wherein said horizontal structural support comprises a structural connector removably secured between respective upper ends of said first and second upright structural supports.

23. The ready to assemble simulated fireplace insert kit of claim 9,

said kit further comprising a horizontal structural support extending between upper ends of said first and second upright structural supports.

24. The ready to assemble simulated fireplace insert kit of claim 22,

wherein said horizontal structural support comprises a structural connector removably secured between respective upper ends of said first and second upright structural supports.

25. The ready to assemble simulated fireplace insert kit of claim 1,

wherein said foundation includes an upwardly facing rear channel, said lower peripheral edge of said rear imaging screen of said firebox panel removably received in said rear channel.

26. The ready to assemble simulated fireplace insert kit of claim 4,

wherein said foundation includes left and right upwardly facing side channels, said side panel portions of said firebox panel removably received in said side channels.

Accordingly, the present disclosure provides a unique and novel ready to assemble fireplace kit and/or combined fireplace kit/furniture kit concept that is highly desirable in the marketplace.

### BRIEF DESCRIPTION OF THE DRAWINGS

These and other features, aspects, and advantages of the present invention will become better understood with reference to the following description, appended claims, and accompanying drawings where:

FIGS. 1-4 illustrate an exemplary prior art ready to assemble furniture console configured and arranged to receive a prior art fully welded box construction simulated fireplace insert into a predefined firebox insert cavity;

FIG. 5 is a perspective view of an exemplary simulated fireplace insert kit in accordance with the teachings of the present invention;

FIG. 6 is an exploded perspective view thereof showing the individual component parts;

FIGS. 7-9 are front, side and top views thereof;

FIG. 10 is a cross-sectional view of the electronic firebed assembly taken along line 10-10 of FIG. 9;

FIGS. 11-13 are various views of the foundation heating unit subassembly;

FIGS. 14-17 are various view of the face frame assembly with upright structural supports;

FIGS. 18-22 are enlarged views of the face frame and upright structural supports illustrating the arrangement of the inwardly facing glass channel and the rearwardly facing channel tab and associated weld lines;

FIGS. 23-24 illustrate assembly of the face frame and upright structural supports to the foundation unit, unfolding of the firebox panel and assembly with the foundation unit and face frame;

FIGS. 25-26 illustrate assembly of the log set to the ember bed grate assembly and assembly of the ember bed log set assembly with foundation unit/face frame and firebox panel subassembly;

FIG. 27 illustrates insertion of the glass panel into the glass channels on the face frame;

FIG. 28 illustrates a fully assembly simulated fireplace insert kit;

FIGS. 29-30 illustrate assembly of the completed fireplace insert kit into the firebox cavity in an exemplary furniture piece;

FIGS. 31-36 are various view of another exemplary face frame subassembly with alternative face plate attachment to the side flanges and an alternative glass panel channel location;

FIGS. 37-58 are various views of another exemplary embodiment of the ready to assemble fireplace insert with a modified glass panel support arrangement, fire bed alignment and grate structures, and wiring arrangements;

FIGS. 59-66 illustrate the stepwise assembly of the various components of the fireplace insert kit and final assembly with an associated furniture kit similar to the assembly steps as shown FIGS. 23-30;

FIGS. 67 and 68 illustrate exemplary 23″ and 26″ assemblies for a simulated fireplace insert kit construction system in accordance with the teachings of the present invention where certain shared components are used within multiple sizes insert kits;

FIGS. 69 and 70 illustrate the two different size kits assembled into exemplary furniture kits;

FIGS. 71 and 72 are exploded perspective views of the two different sets of kit components including shared components;

FIGS. 73-75 are various views of a 23 inch assembly;

FIGS. 76-78 are various view of a 26 inch assembly;

FIG. 79 is a cross-section view of the assembly taken along line 79-79 of FIG. 75, it being understood that the cross-sectional view of both units is identical;

FIGS. 80-82 are front, back and rear perspective views of a 23 inch foundation/heater unit illustrating rear lip channel brackets, left and right lip channel brackets and left and right face frame tabs;

FIGS. 83-85 are front, back and rear perspective views of a 26 inch foundation/heater unit illustrating rear lip channel brackets, left and right extended lip channel brackets and left and right extended face frame tabs;

FIGS. 86-91 are various view of the shared simulated firebed assembly used in both size configurations, including the ember bed housing, logs, internal electronic and lighting components, and grate;

FIGS. 92-102 illustrate another exemplary fireplace insert kit assembly and insert kit construction system wherein multiple size units are constructed from a plurality of shared common components combined with unique sized components for each different size unit;

FIGS. 103-107 are various views of an exemplary upright structural support commonly used in the embodiments of FIGS. 86-102;

FIGS. 108-118 illustrate stepwise assembly of an exemplary 23 inch fireplace insert kit as illustrated in FIGS. 92-94;

FIGS. 119-122 illustrate an exemplary simulated fireplace insert kit where the firebox panel has a rear imaging screen and a top portion with panel edge support;

FIGS. 123 and 124 illustrate an exemplary simulated fireplace insert kit where the firebox panel has a rear imaging screen portion and a top portion with an L-shaped panel edge support;

FIGS. 125 and 126 illustrate another exemplary simulated fireplace insert kit where the firebox panel has a rear imaging screen portion and a top portion and the upright structural supports include a support tab;

FIGS. 127-129 illustrate still another exemplary simulated fireplace insert kit where the firebox panel has a rear imaging screen portion and a top portion and the upright structural supports are formed as a C-shaped frame joined at the top by a structural connector;

FIGS. 130-132 illustrate an exemplary simulated fireplace insert kit where the firebox panel has a rear imaging screen portion, a top portion and side portions extending down from the top portion;

FIGS. 133-137 illustrate an exemplary simulated fireplace insert kit where the heater/face plate assembly is moved to the top of the assembly and is supported at the rear by a structural spine;

FIGS. 138-140 illustrate another exemplary simulated fireplace insert kit where the heater/face plate assembly is moved to the top of the assembly and is supported at the rear by a sheet metal firebox panel which may include sheet metal side panels;

FIGS. 141-143 illustrate still another exemplary simulated fireplace insert kit where the heater/face plate assembly is moved to the top of the assembly and is supported at the rear by a sheet metal firebox panel which may include MDF side panels;

FIGS. 144-145 illustrate a further exemplary simulated fireplace insert kit where the heater/face plate assembly is moved to the top of the assembly and is supported at the rear by a sheet metal firebox panel with no side panels;

FIGS. 146-147 illustrate an exemplary simulated fireplace insert kit where the heater assembly is moved to the top of the assembly and is supported at the front by a full square face frame and at the rear by an MDF firebox panel with a rear structural spine;

FIGS. 148-149 illustrate an exemplary simulated fireplace insert kit where the firebox panel has a rear imaging screen and a forward extending top portion and wherein the viewing panel and top portion are supported within a fully square face frame;

FIGS. 150-151 illustrate an exemplary simulated fireplace insert kit where the firebox panel has a top portion and downward side portions and wherein the glass viewing panel and top portion are supported within a fully square face frame;

FIGS. 152-154 illustrate an exemplary simulated fireplace insert kit where the heater/face plate assembly is moved to the top of the assembly and is supported at the rear by a sheet metal firebox panel which includes sheet metal side panels but no face frame assembly; and

FIGS. 155-156 illustrate an exemplary simulated fireplace insert kit where the firebox panel has a rear imaging screen with no top portion and no side portions.

### DETAILED DESCRIPTION OF THE EXEMPLARY EMBODIMENTS

Certain exemplary embodiments will now be described to provide an overall understanding of the principles of the structure, function, manufacture, and use of the device and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present disclosure. Further, in the present disclosure, like-numbered components of the embodiments generally have similar features, and thus within a particular embodiment each feature of each like-numbered component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Further, to the extent that directional terms like top, bottom, up, or down are used, they are not intended to limit the systems, devices, and methods disclosed herein. A person skilled in the art will recognize that these terms are merely relative to the system and device being discussed and are not universal.

Generally, the present disclosure provides a unique and novel ready to assemble simulated fireplace insert kit which can be provided on its own and/or combined and shipped together with a ready to assemble furniture kit to provide a novel and unique solution in the ready to assemble furniture product category. Like many prior art furniture pieces, the ready to assemble simulated fireplace insert is broken down into individual components that can more easily be packed and shipped in a flat pack format thus reducing shipping cost and storage space.

In a first aspect of the invention, there is provided a ready to assemble simulated fireplace insert kit comprising a firebox panel having a rear imaging screen portion with a forwardly extending portion, a foundation having a front, a top, opposing left and right sides, and a rear wherein the firebox panel has lower peripheral edges removably secured to the foundation. The foundation may include an internal heater unit for generating heat. The insert kit may further include first and second upright structural supports each having a lower end removably secured to the foundation or a face frame adjacent to the front, wherein the forwardly extending panel portion of the firebox panel engages the uprights structural supports and whereby the foundation and the upright structural supports transfer structural rigidity to the firebox panel. A face frame or grill may be assembled with the foundation and/or upright supports in various configurations. A simulated electronic firebed assembly may be removably received on the foundation and may be controlled in conjunction with the heater unit.

In another aspect of the invention, there is provided a furniture assembly comprising, in combination a ready to assemble simulated fireplace insert kit and a furniture piece which may in some embodiments also comprise a ready to assemble kit. The ready to assemble simulated fireplace insert kit comprises a firebox panel having a rear imaging screen portion with a forwardly extending portion, a foundation having a front, a top, opposing left and right sides, and a rear wherein the firebox panel has lower peripheral edges removably secured to the foundation. The foundation may include a heater unit for generating heat. The insert kit may further include first and second upright structural supports each having a lower end removably secured to the foundation or a face frame adjacent to the front. The forwardly extending panel portion of firebox panel engages the uprights structural supports whereby the foundation and the upright structural supports transfer structural rigidity to the firebox panel. A simulated firebed assembly may be removably received on the foundation and may be controlled with the heater unit. The furniture piece may comprise a furniture base having an upper surface, a furniture top having a lower surface, left and right furniture sides extending between the upper surface of the furniture base and the lower surface of the top and structurally supporting the top above the base when assembled therewith to form an insert cavity within the furniture assembly, and wherein the assembled simulated fireplace kit is slidably received into the insert cavity in the furniture piece.

In another aspect of the invention, a simulated fireplace insert system for constructing a plurality of simulated fireplace insert assemblies of different widths using shared components comprises a foundation/heater assembly configured to be installed within a fireplace housing wherein the foundation/heater assembly includes a foundation/heater body, a first face frame or grill that is selectively couplable to the foundation/heater body, and a second face frame or grill that is alternatively selectively couplable to the foundation heater body, and wherein the first face frame has a first length, and the second face frame has a second width/length that is different than the first face frame width/length.

In a further aspects of the invention, a simulated fireplace insert system for constructing a plurality of simulated fireplace insert assemblies of different widths using shared components comprises a shared foundation having a front, a top, opposing left and right sides, and a rear, shared first and second upright structural supports each having a lower end removably secured or coupled to said foundation adjacent said front, a first firebox panel having a rear imaging screen portion having a first width and a forwardly extending portion, a second firebox panel having a rear imaging screen portion having a second width greater than said first width, and a forwardly extending panel portion, a first simulated firebed assembly having a first width, a second simulated firebed assembly having a second width, and shared first and second upright support extensions.

The shared foundation and upright structural supports may be assembled with the first firebox panel and the first simulated firebed assembly to form a first simulated fireplace assembly having a first width, the first and second upright supports are removably secured to the foundation, the first simulated firebed is received on the foundation, the first firebox panel having a lower peripheral edge removably secured to the foundation, the forwardly extending panel portion of the first firebox panel engaging the upright structural supports whereby the foundation and the upright structural supports transfer structural rigidity to the first firebox panel.

The shared foundation and upright structural supports may be assembled with the second firebox panel, the second simulated firebed assembly and the first and second upright support extensions to form a second simulated fireplace assembly having a second width, the first and second upright supports removably coupled to the foundation through the first and second upright support extensions, the second simulated firebed is received on said foundation, the second firebox panel having a lower peripheral edge removably secured to the foundation, the forwardly extending panel portion of the second firebox panel engaging the upright structural supports whereby the foundation and the upright structural supports transfer structural rigidity to the second firebox panel.

In still a further aspect of the invention a method for assembling an electric fireplace and furniture assembly combination may comprise the steps of: providing an assembly that includes a furniture assembly in an unassembled configuration, the furniture assembly including a plurality of unassembled furniture components, and further providing a simulated electric fireplace in an unassembled configuration, the simulated electric fireplace including a foundation/heater assembly, a firebed assembly that is configured to generate a simulated flame, and an electrical connection assembly; and assembling the furniture structural components to define a insert cavity within the assembled furniture; and positioning the simulated electric fireplace assembly in the insert cavity opening.

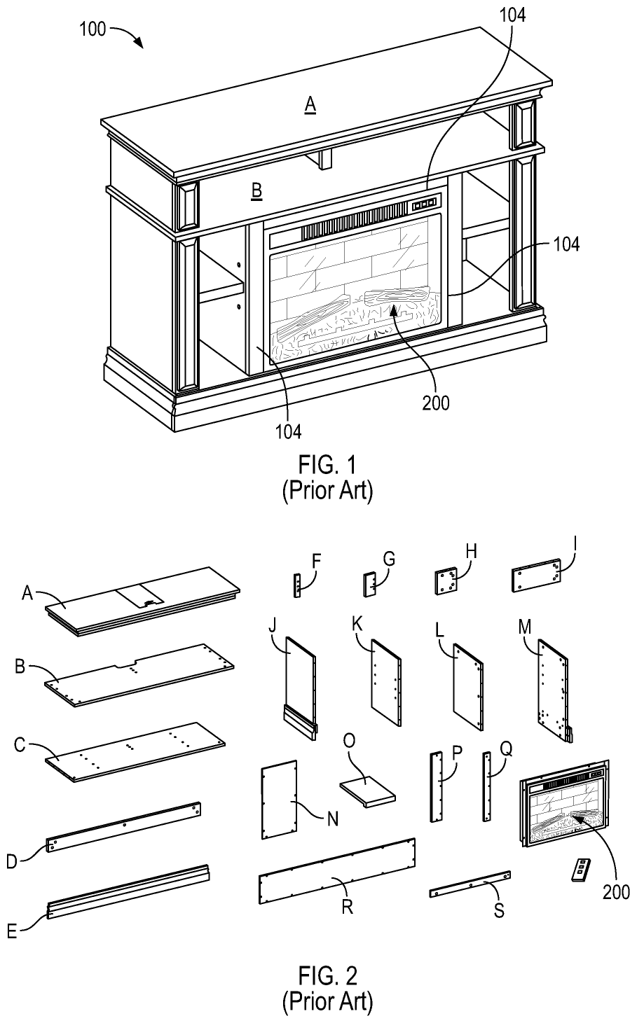

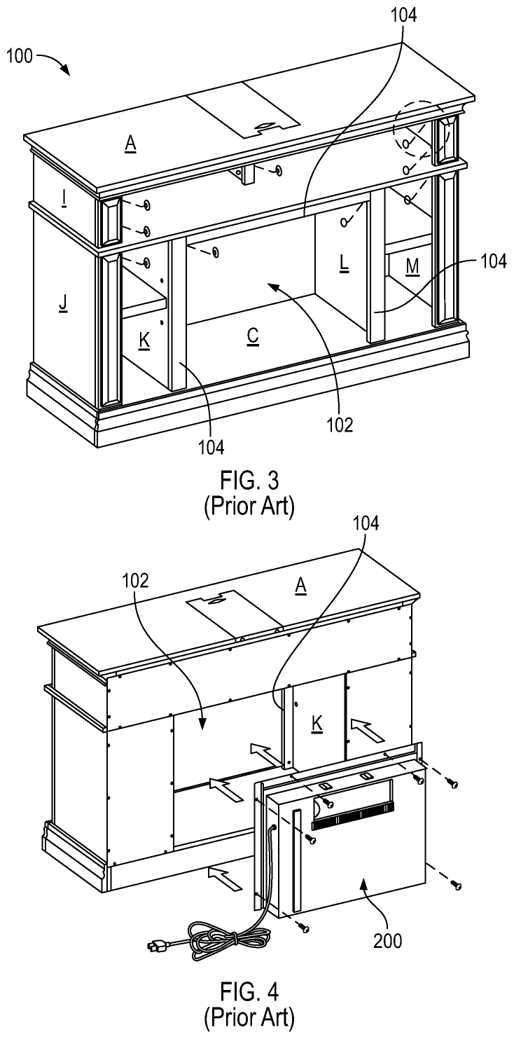

FIGS. 1-4 illustrate a prior art ready to assemble furniture console kit 100 which is configured and arranged to receive a conventional box construction fireplace insert 200. FIG. 2 illustrates the prior art electric fireplace insert 200 as a completed welded box unit shipped as a separate completed piece.

Generally, referring to FIGS. 1-4, the ready to assemble furniture console kit 100 comprises a base (C) having an upper surface, a top (B) having a lower surface and left and right side panels (K,L) extending between the upper surface of the base C and the lower surface of the top B and structurally supporting top above the base when assembled therewith to form a generally rectangular insert cavity 102 within the console assembly 100. The top (C) and left and right side panels (K,L) including inwardly turned stile bars 104 forming an insert cavity frame.

As seen in FIG. 4, the prior art box construction insert 200 is slidably received into the insert cavity 102 with the top and side trims in snug facing engagement with the rearwardly facing surfaces of the stile bars 104.

While a particular exemplary embodiment of a ready to assemble furniture piece/console kit 100 is illustrated herein, the teachings of the present invention are equally applicable to any other furniture console and piece which generally provides a firebox cavity 102 capable of receiving such a fireplace insert 200 or any fireplace insert kit as to be described herein. Such consoles or pieces 100 may include, but are not limited to, mantles, shelving units desks, buffets, media cabinets, etc. and may in some embodiments include shelves, doors, etc. as common with various furniture pieces.

Likewise, the furniture console or piece may also comprise in some embodiments any type of assembled or finished furniture piece having a firebox cavity or opening capable of receiving the ready to assemble fireplace insert as described herein.

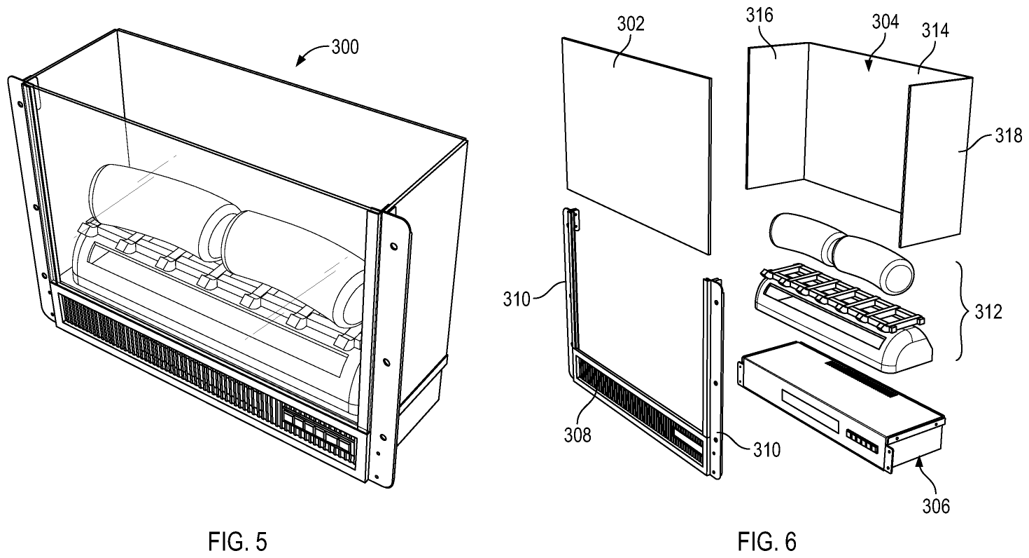

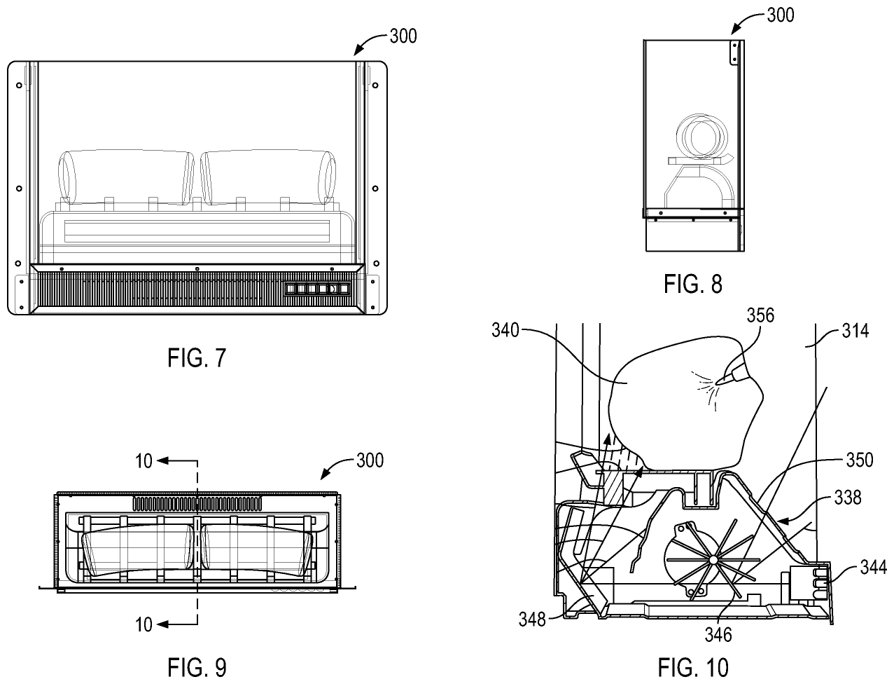

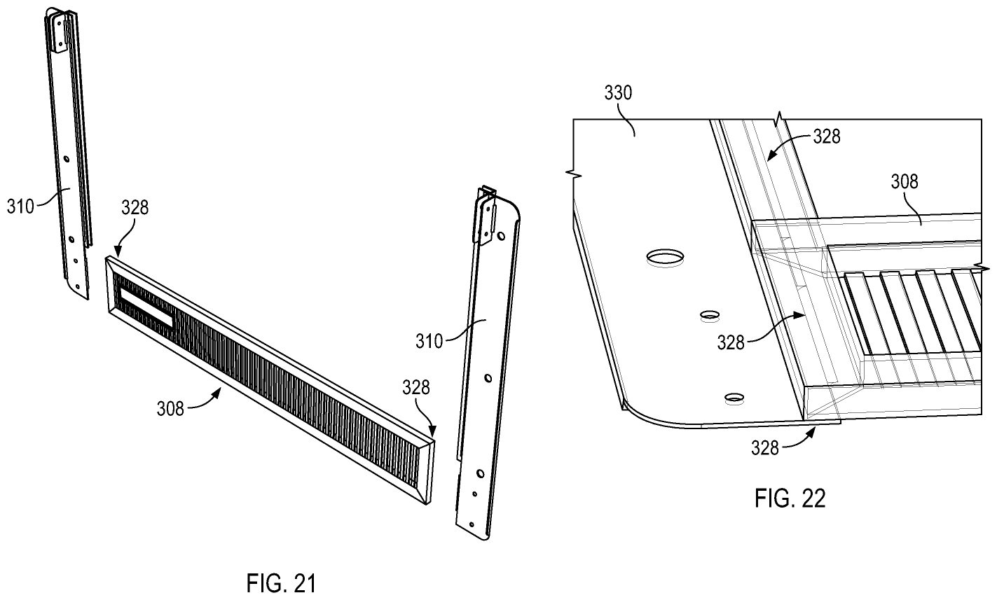

Turning now to FIGS. 5-30, an exemplary embodiment of a ready to assemble simulated fireplace insert kit illustrated and generally indicated at 300. As best seen in FIG. 6, the ready to assemble simulated electric fireplace insert kit 300 may be broken down into parts and subassemblies comprising a front viewing panel or glass panel 302, a firebox panel 304, a foundation unit 306, a face frame or grill 308 including upright structural supports 310, and an electronic fire bed assembly 312.

The front viewing panel or glass panel 302 is packed separately from the structural components so that it can be shipped separately in appropriate protective packaging. The viewing panel 302 may comprise tempered glass or may in some embodiments comprise a mesh screen panel, or still further in some embodiments may not be included such that the front of the assembled insert kit 300 is open.

The firebox panel 304 has a rear imaging screen panel portion 314 and left and right side panel portions 316,318 to form the rear and sides of a decorative fireplace interior. Additionally, it should be clear that the rigid panel 304 also provides structural stability to the face frame 308 and upright structural supports 310 when the insert unit 300 is assembled and the panel 304 is secured both to the foundation unit and to the face frame upright structural supports 310.

The firebox panel 304 may comprise a rigid, planar panel substrate, such as an ⅛ inch MDF panel, and a decorative vinyl laminate surface film applied to the rigid panel substrate. The vinyl film may be printed with any of a variety of different fireplace interiors or may simply be colored black. It should be understood that other types of rigid panel materials may be used, such as metal, plastic, other wood materials, and the specific exemplary embodiments should not be considered limiting. Likewise, the decorative surface covering or film may comprise alternative materials and coverings, such as paint or other types of plastic, paper materials, films etc.

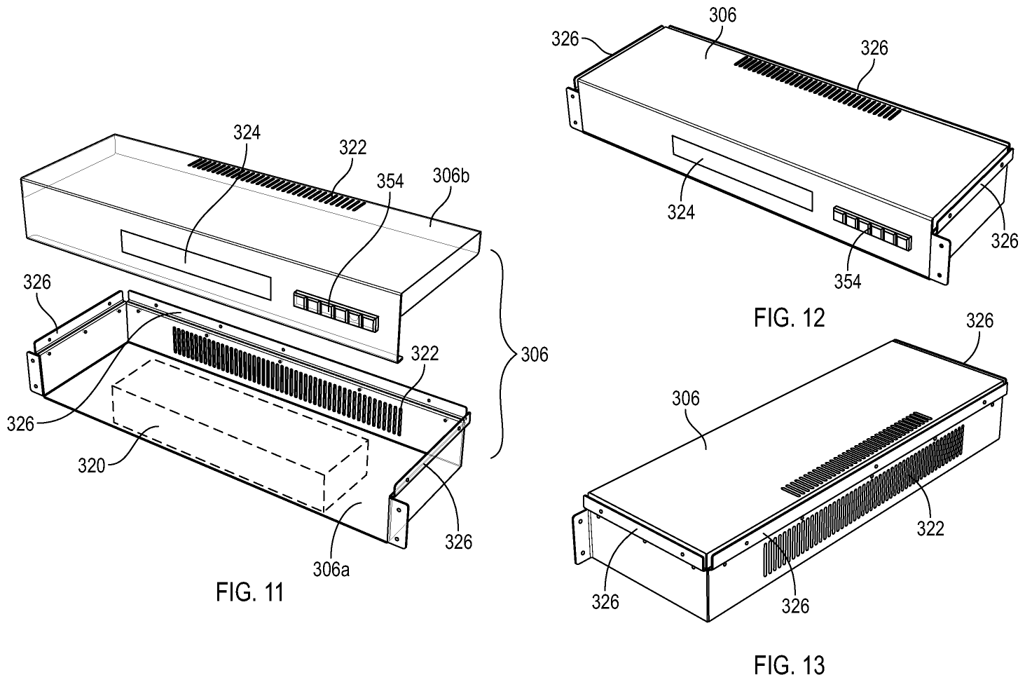

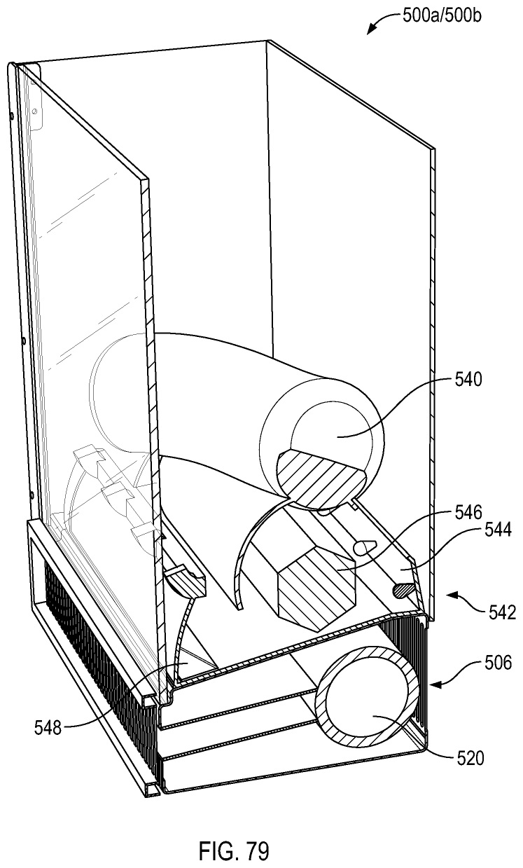

The foundation unit 306 (FIGS. 11-13) may be constructed from several housing parts 306A,306B and may enclose a heater assembly 320 as known in the art (See exemplary FIG. 79). The foundation 320 includes front, rear, top, bottom and side surfaces. The front and various other surfaces include intake 322 and exhaust slots or grills 324 for heated air delivery through the front face. The top surface of the foundation/heater unit 306 as well as the left and right side peripheral edges thereof have upwardly facing lip channels 326 which receive the peripheral edges of the firebox panel 304. The lip channels 326 may be formed as part of one of the portions of the housing 306A (see FIG. 11) or may be separate parts that are assembled to the housing 306.

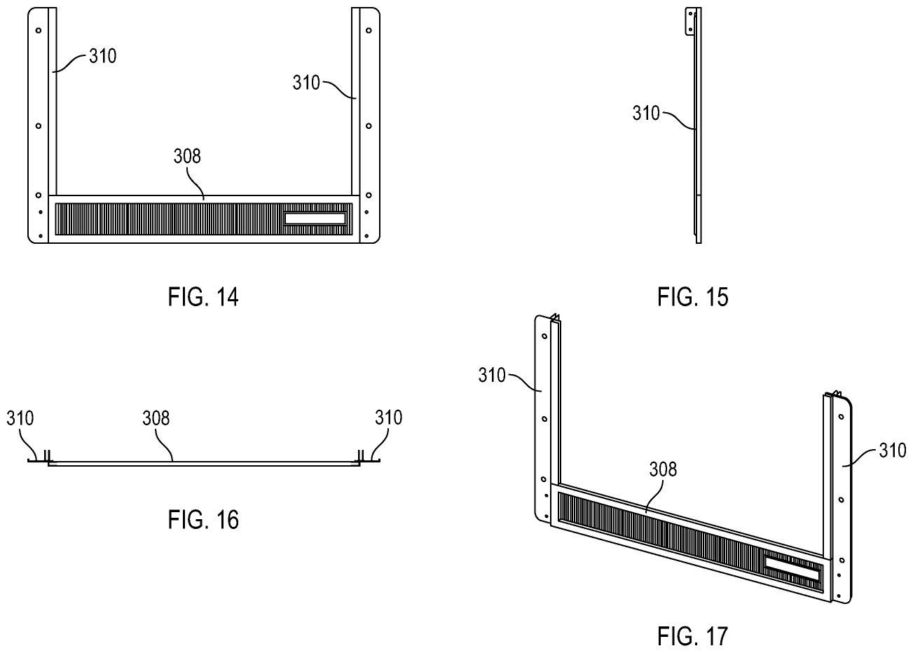

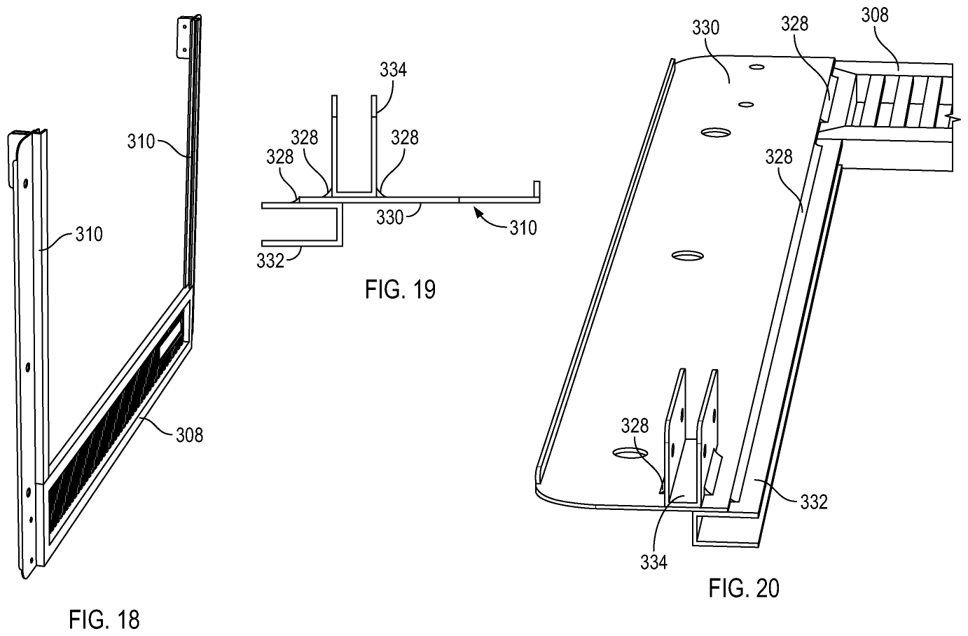

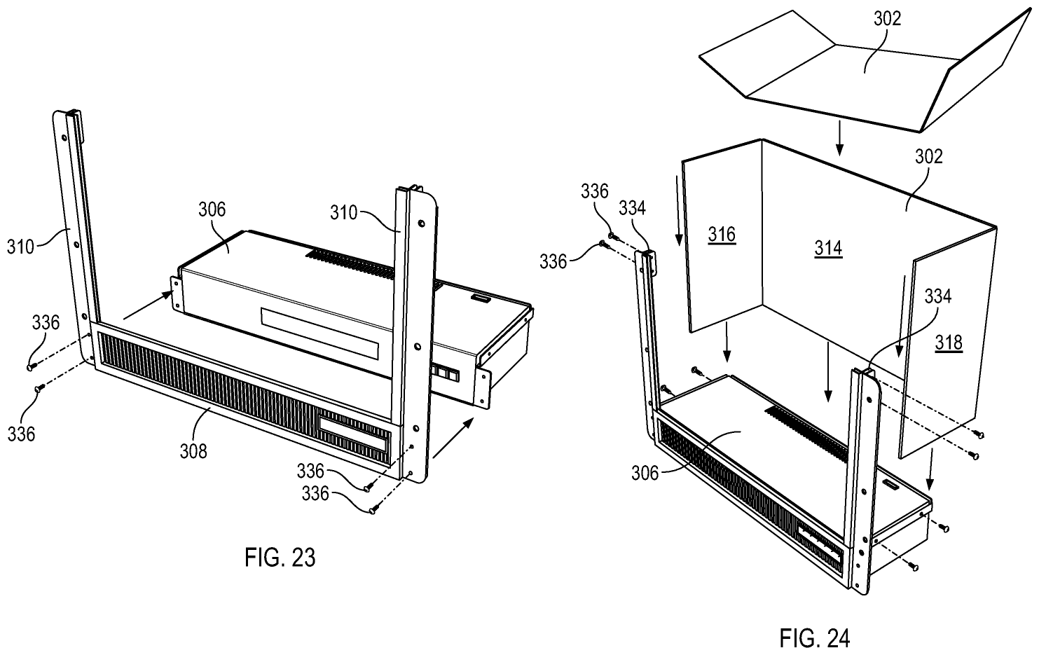

Turning to FIGS. 14-22, the U-shaped face frame comprises a lower face panel or grill plate 308 with an upper edge surface with the left and right upright structural supports 310 secured thereto. In the present configuration, the upright structural supports 310 are welded to the face panel 308 (See FIGS. 19, 20 and 22 for exemplary weld joints 328). However, in later embodiments, it will be seen that the face frame 308 and upright structural supports 310 may be separate components and may be permanently or removably attached to the foundation 306. The face frame/upright assembly is configured and arranged for assembled attachment to the front face of the foundation unit 306 (See FIGS. 23-24). As best seen in FIGS. 18-22, each of the upright structural supports 310 (configured in left and right versions) has a main flat body portion 330 which provides a mounting surface and further has an inwardly facing elongated channel 332 for receiving the viewing panel 302 therebetween. Each of the upright supports 310 further has a rearwardly facing channel tab 334 adjacent the top thereof for receiving the firebox panel 334. The exact positioning of the channel tabs 334 may be altered in various embodiments and may be located towards the center or bottom or may be in multiple locations. Other methods for securing the firebox panel 304 to the upright supports 310 are also contemplated. The firebox panel 304 as described above is configured and arranged for assembled attachment to the foundation/heater unit 306 and the upright supports 310 wherein respective bottom peripheral edge portions thereof are received and secured into the upwardly facing lip channels 326, and respective front edge portions thereof are received and secured into the rearwardly facing channel tabs 332 (See assembly at FIG. 24). Fasteners 336 may be inserted through aligned openings in the tabs 334 and lip channel walls 326, such as illustrated in FIGS. 24 and 45-48.

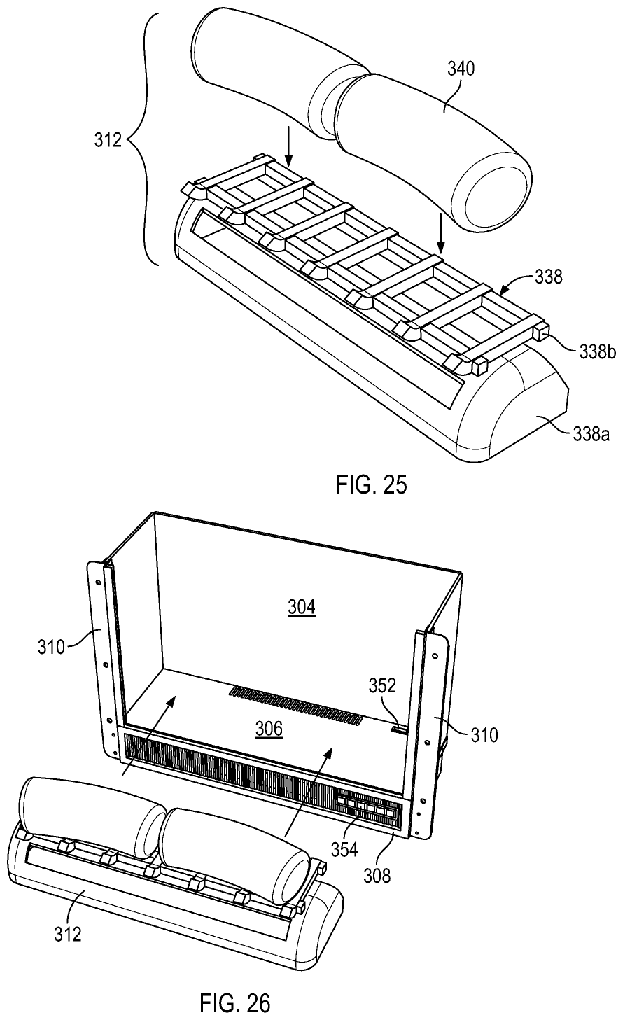

The electronic simulated firebed 312 in the illustrated examples is best seen in FIGS. 10 and 25 and comprises an ember bed and grate assembly 338 configured and arranged for assembled positioning on the top surface of the foundation/heater unit 306 in front of the firebox panel 304. A log set 340 may also be provided. The ember bed and grate 338 simulate a conventional wood fireplace. However, it is equally contemplated that the firebed 312 may comprise other forms of simulated firebeds such a river rock or crystal stones.

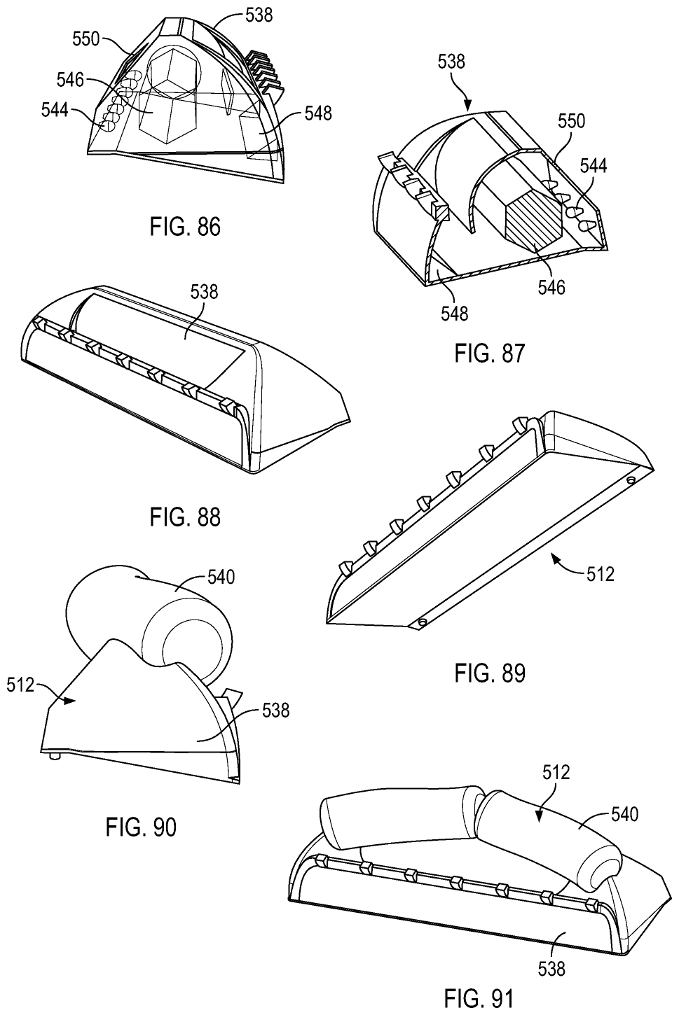

The exemplary ember bed grate assembly 338 includes a housing portion 338A which encloses an electronic fire simulating device 342. In particular, the details of the Applicant's firebed assembly are set forth in U.S. Pat. No. 10,731,810, the entire contents of which are incorporated herein by reference. The cross-sectional view illustrated in FIG. 10 (as well as FIGS. 79, 86 and 87) are representative of the internal configuration of the fire simulating device as used in the present embodiments.

Referring to FIG. 10, typically, such as device may include an LED light bar 344, flicker rod 346, a front reflector 348, and a rear flame screen 350 which will project glowing and flickering light throughout the embed bed and through the flame screen 350 onto the imaging screen portion 314 of the firebox panel 304. Electrical connections for the ember bed assembly may be made by suitable connections 352 (such as a USB plug connection) through the top surface of the foundation unit 306, which also encloses an electronic controller 354 for both the heater unit 320 and the ember bed fire simulating device 342. The ember bed 338 further includes a simulated grate structure 338B on an upper surface thereof which receives the simulated log set 340. In some embodiments, the grate structure 338B may be molded as part of the ember bed or may also be provided separate from the ember bed. In some embodiments, the firebed 312 housing mau include alignment feet 313 which are received into alignment indents 315 in the top of the foundation 306. The log set 340 may in some embodiments also include lighting elements 356 which can be connected with the ember bed assembly as needed (See also FIG. 44).

In an exemplary assembly process, assembly of the ready to assemble fireplace insert kit 300 can be completed in a few simple steps as illustrated in FIGS. 23-28.

FIG. 23 illustrates Step 1 assembly of the face frame 308/Upright 310 assembly to the foundation unit 306 with 4 screws.

FIG. 24 illustrates Step 2 unpacking of the rear panel 304, folding and assembly with the foundation/heater unit and face frame with screws.

FIG. 25 illustrates Step 3 assembly of the log set 340 to the ember bed grate assembly 338.

FIG. 26 illustrates Step 4 placement and assembly of the ember bed log set assembly with foundation unit/face frame subassembly and electrical connection of the firebed with the heater unit controller (USB).

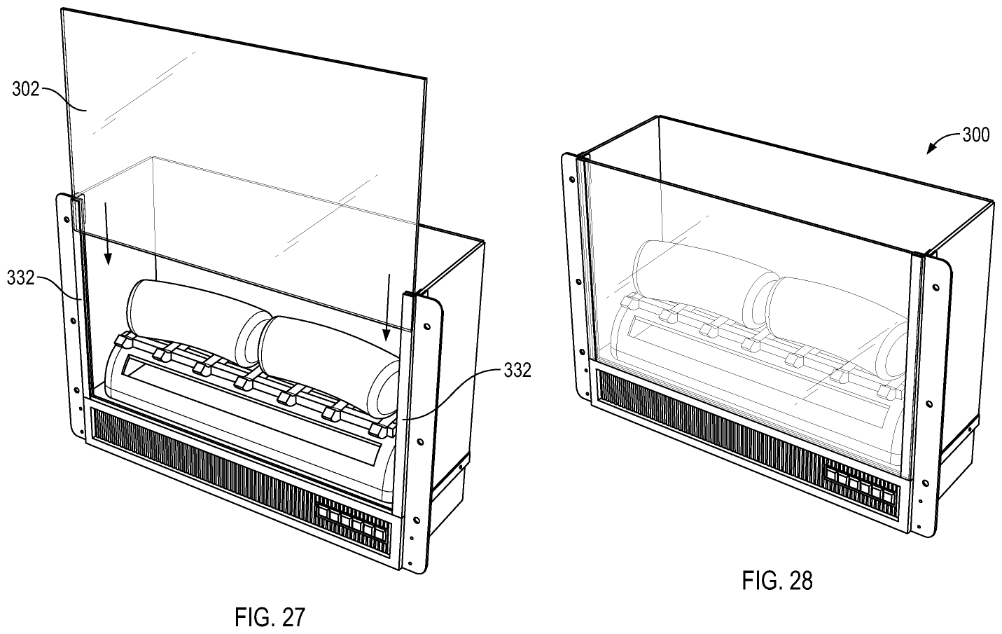

FIGS. 27-28 illustrate final insert kit assembly Step 5 with insertion of the glass viewing panel 302 into the opposed glass channels 332 on the uprights 310. The lower edge of the glass panel 302 rests on the upper surface of the face frame 308. The assembled fireplace insert kit 300 is now ready for assembly with the previously assembled furniture console kit 100 as described hereabove.

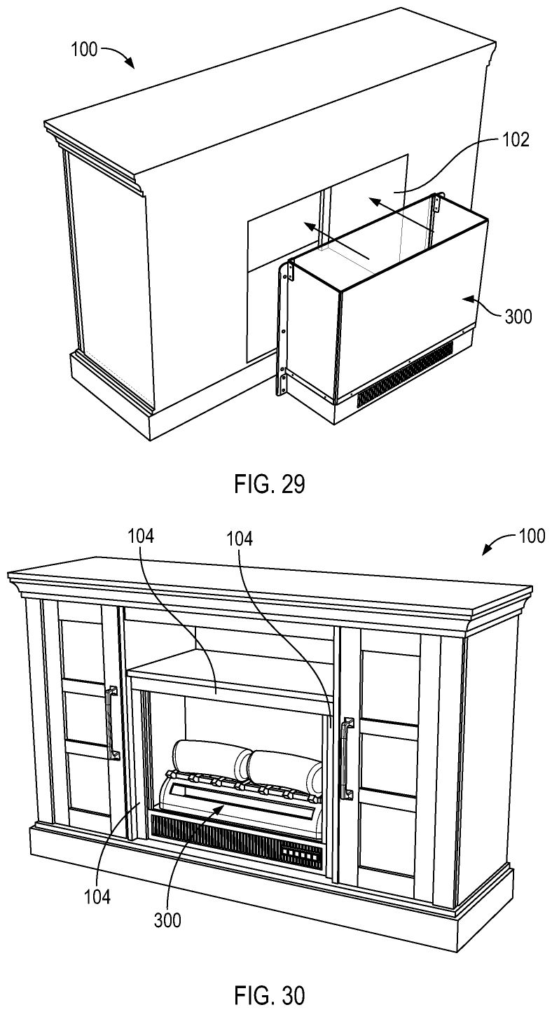

FIGS. 29-30 illustrate Step 6 assembly of the completed fireplace insert kit 300 into the firebox cavity 102 in the furniture console 100 where the face frame 308 and uprights 310 are positioned in snug facing engagement with the back surface of the framing stiles 104. FIG. 30 illustrates the fully assembled and combined fireplace insert kit 300 and furniture console kit 100 in accordance with the invention.

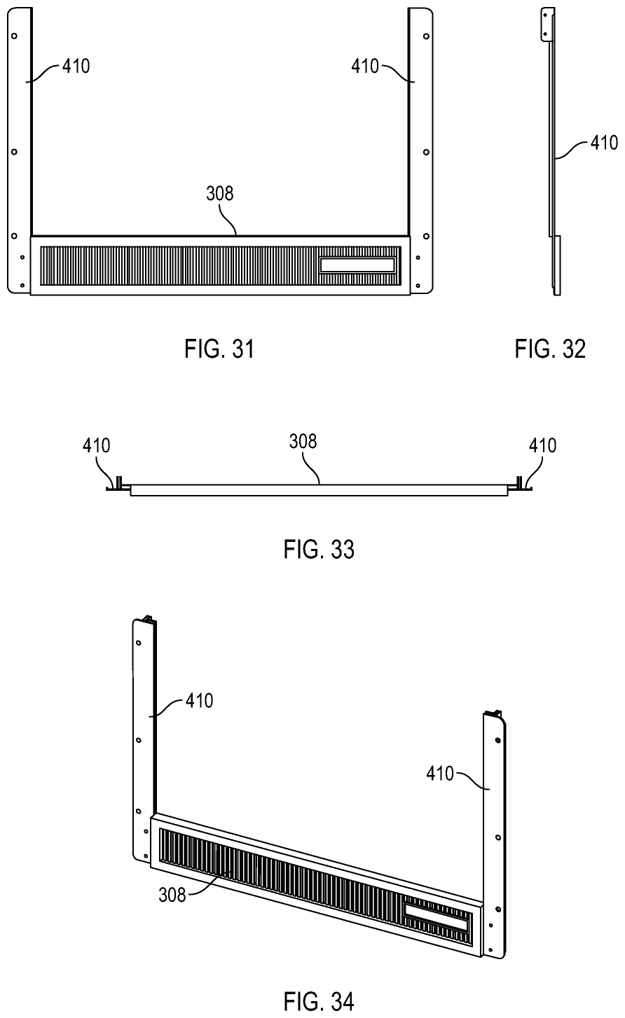

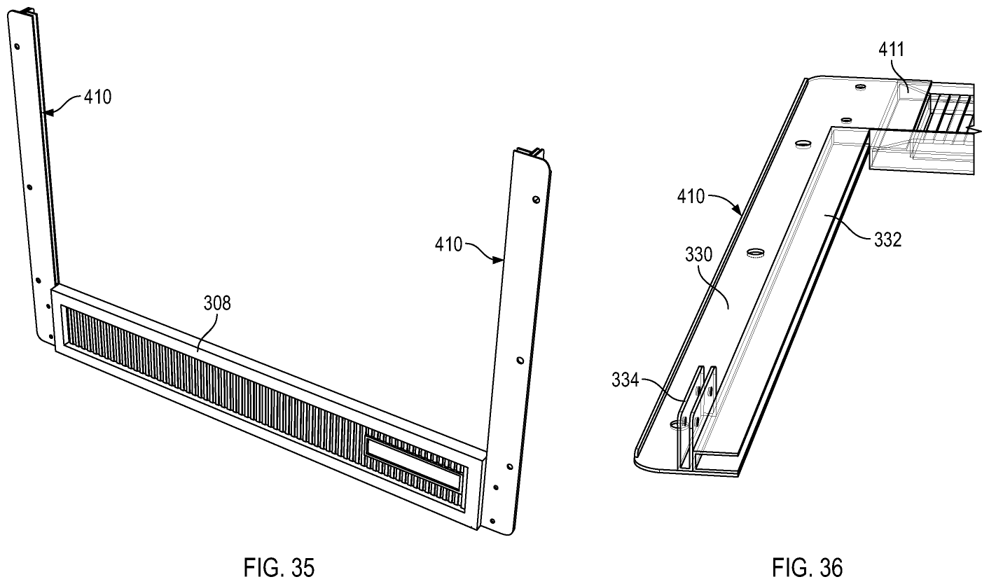

FIGS. 31-36 illustrate another exemplary face frame subassembly with alternative face frame attachment to the upright structural supports 410 and an alternative viewing panel channel location. As best seen in FIG. 36, the front face frame 308 is moved forwardly of an attachment flange 411 so that it protrudes forwardly between the side stiles 104 of the furniture console assembly 100, while the inwardly facing viewing panel channels 432 are moved rearwardly behind the upright body 430 to hide the channels 432 and create a cleaner look from the front of the assembled unit. This also allows the firebox panel tabs 434 to be hidden between the glass channels 432 and less visible from the front of the unit.

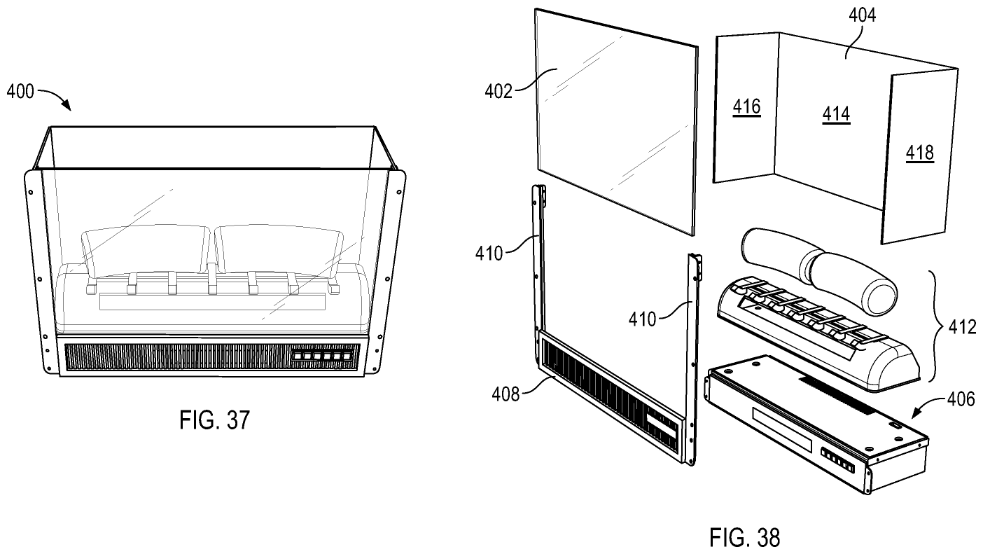

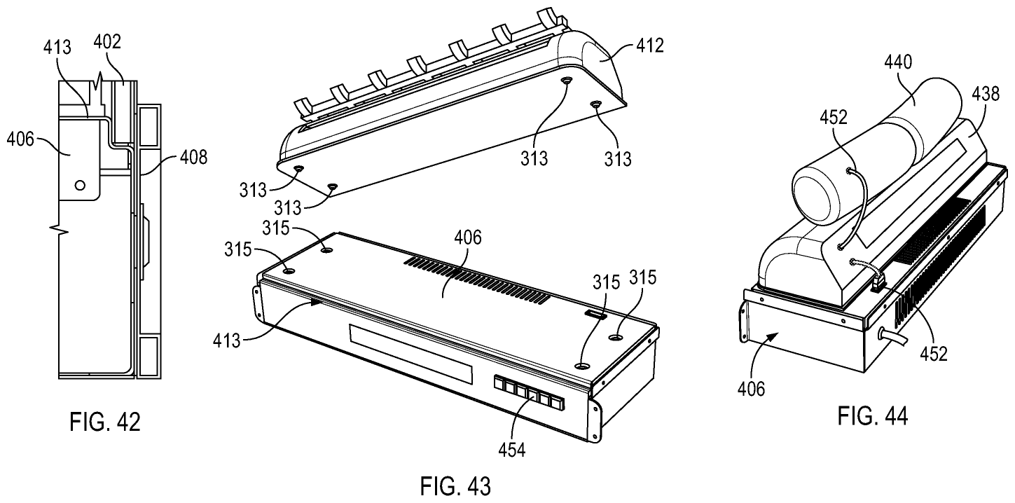

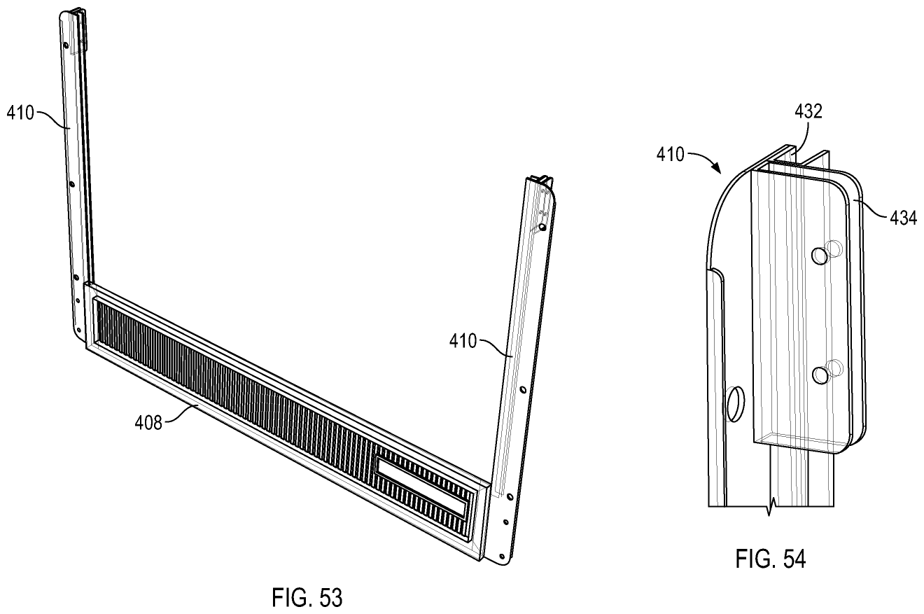

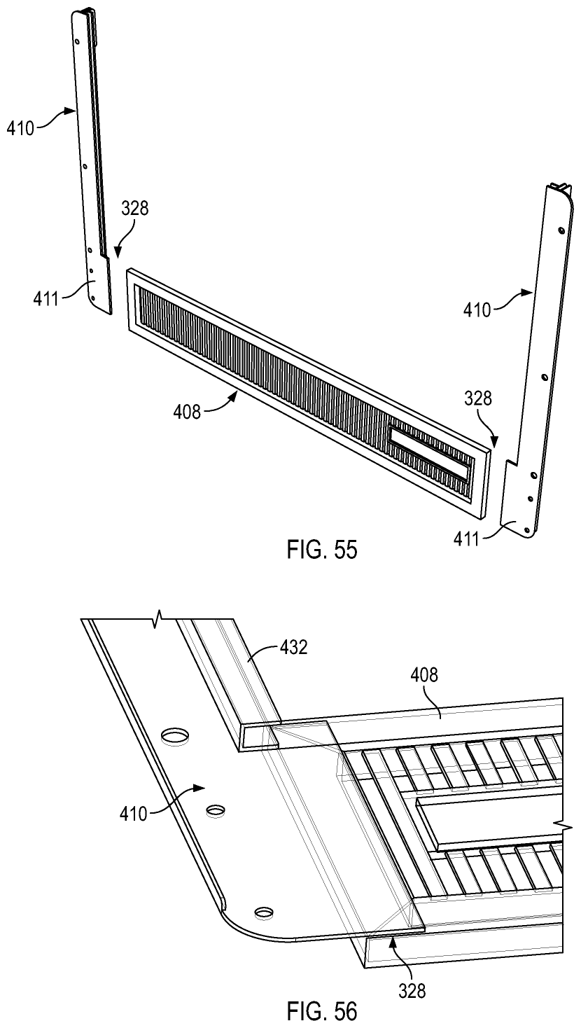

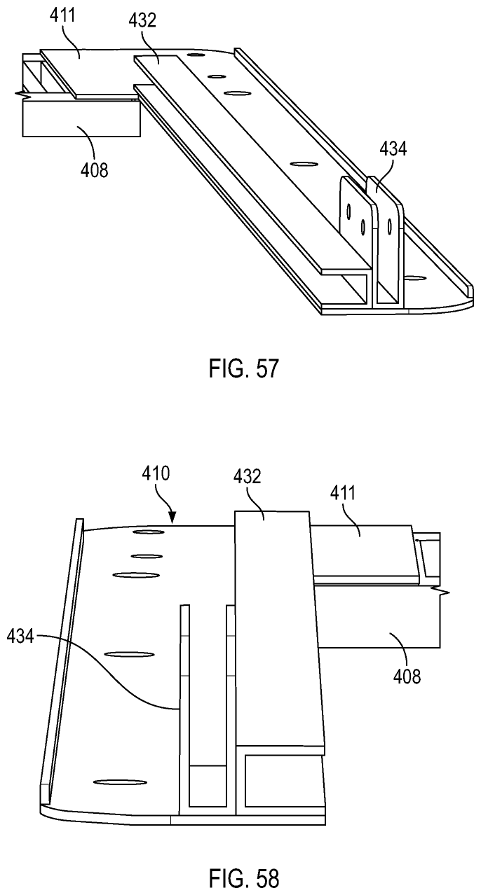

Turning to FIGS. 37-66, there is shown various views of another exemplary embodiment 400 of a ready to assemble fireplace insert kit with a modified glass panel support arrangement, fire bed alignment structures, grate structures, and wiring arrangements. The present kit 400 comprises a front viewing panel or glass panel 402, a firebox panel 404, a foundation unit 406, a face frame 408 including upright structural supports 410 (as described above in FIGS. 31-36), and an electronic fire bed assembly 412. When possible, like parts are numbered similarly to the above-described embodiment and all descriptions of those components are applicable here as well.

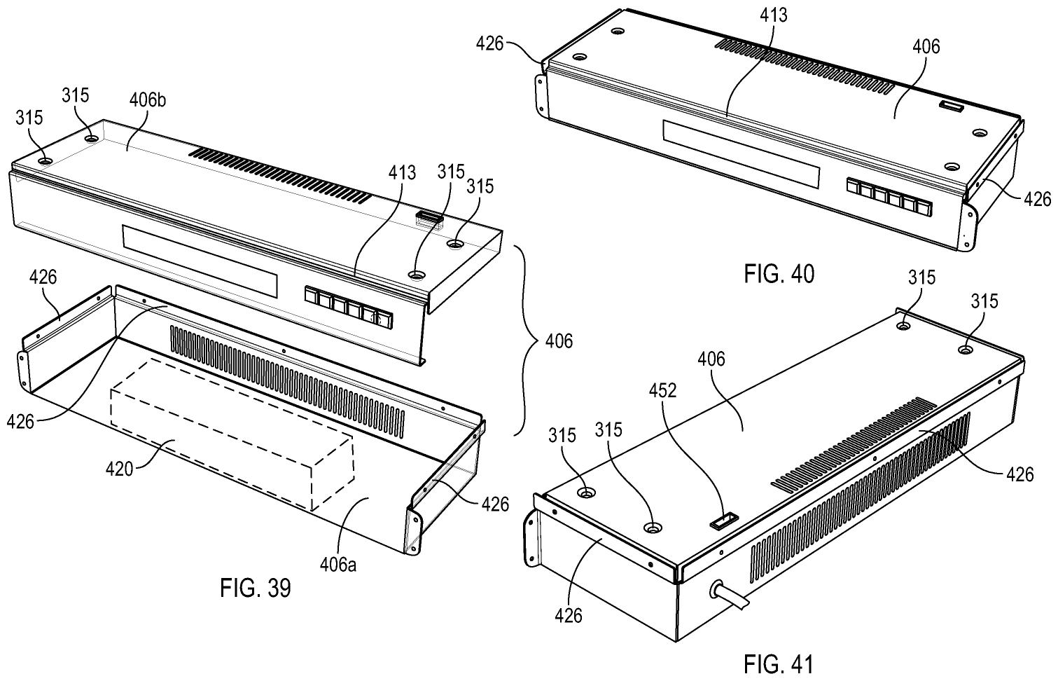

Referring to FIGS. 39-42, there is illustrated an alternative glass shelf structure 413 formed as part of the base 406A of the foundation unit 406. This arrangement allows the glass 402 to slide down below the upper edge of the face plate 308 and provides a better aesthetic appearance of the lower glass edge.

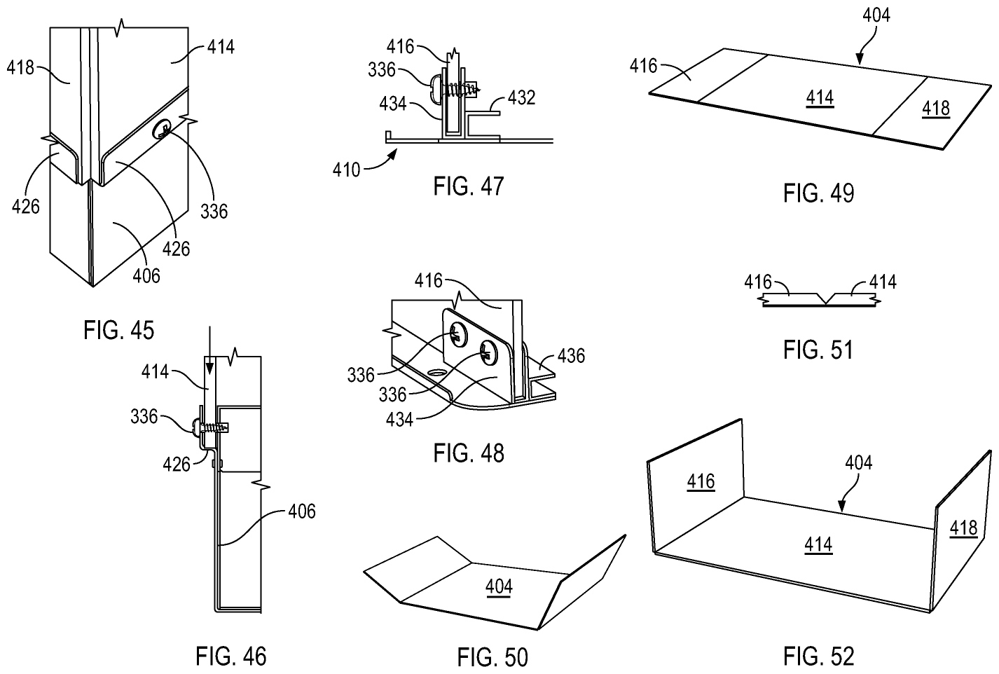

FIGS. 45-52 illustrate exemplary fastener arrangements for securing the firebox panel 404 to both the foundation 406 and to the upright structural supports 410.

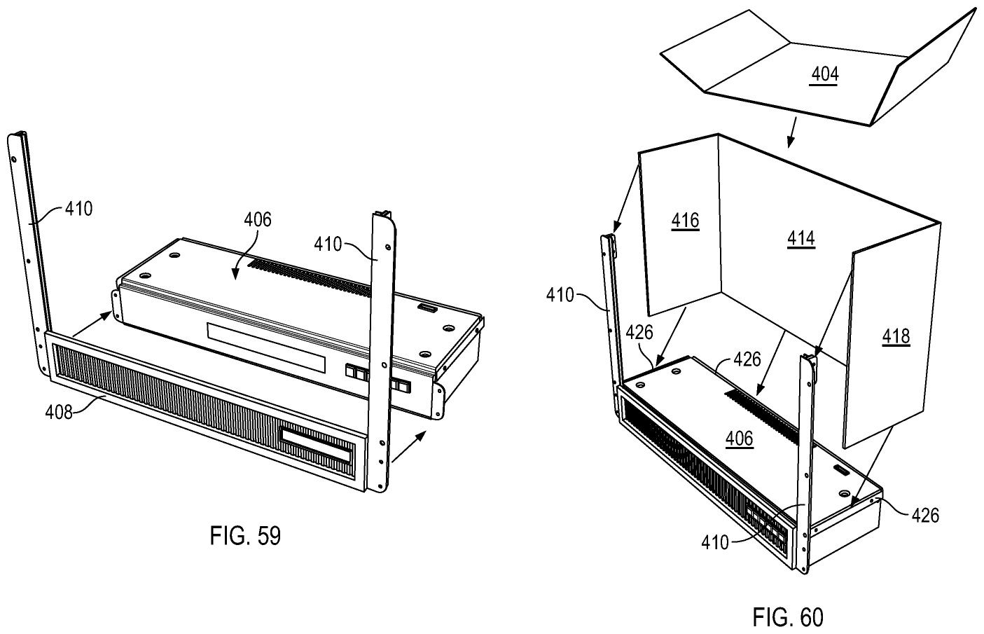

FIGS. 59-66 illustrate the stepwise assembly of the various components of the fireplace insert kit and final assembly with an associated furniture kit as previously described hereinabove relative to FIGS. 23-30.

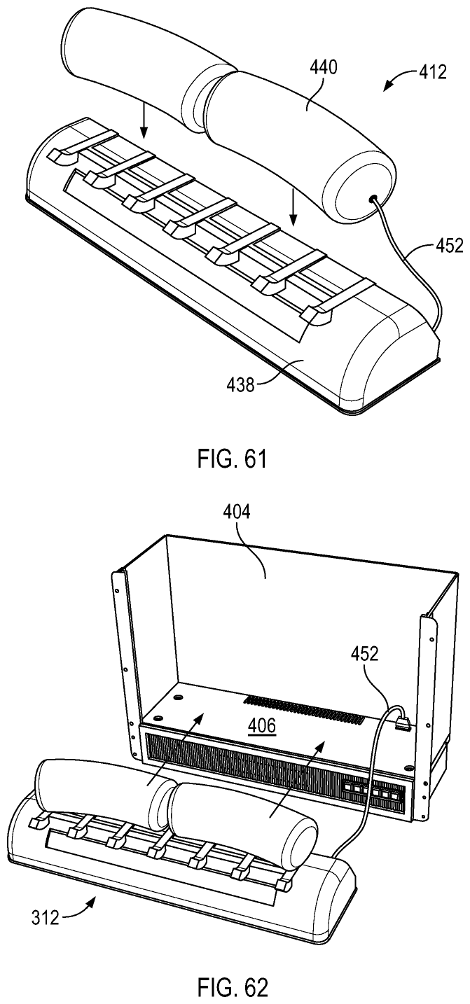

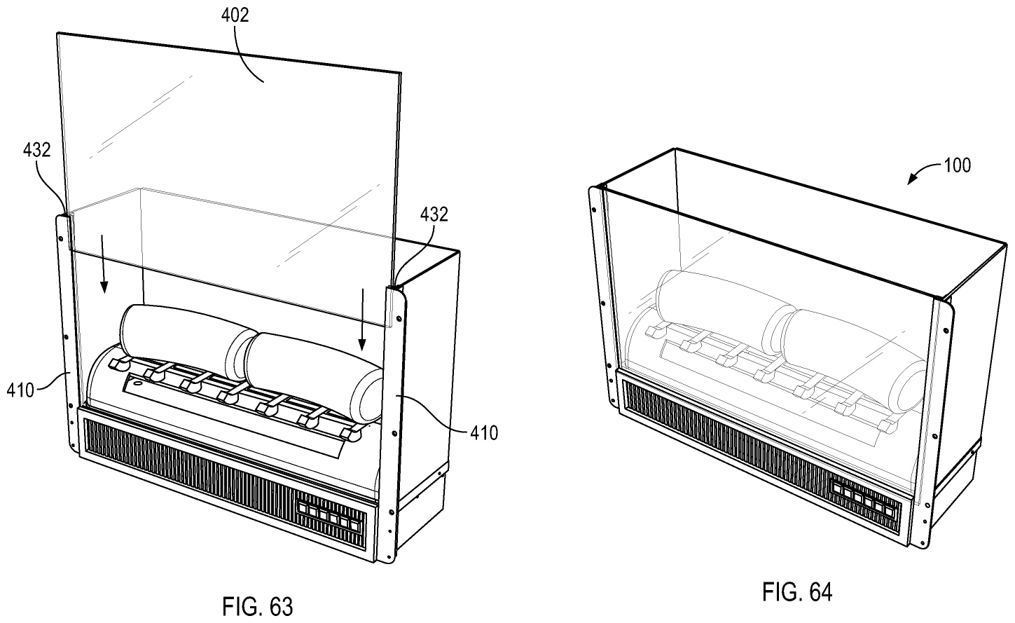

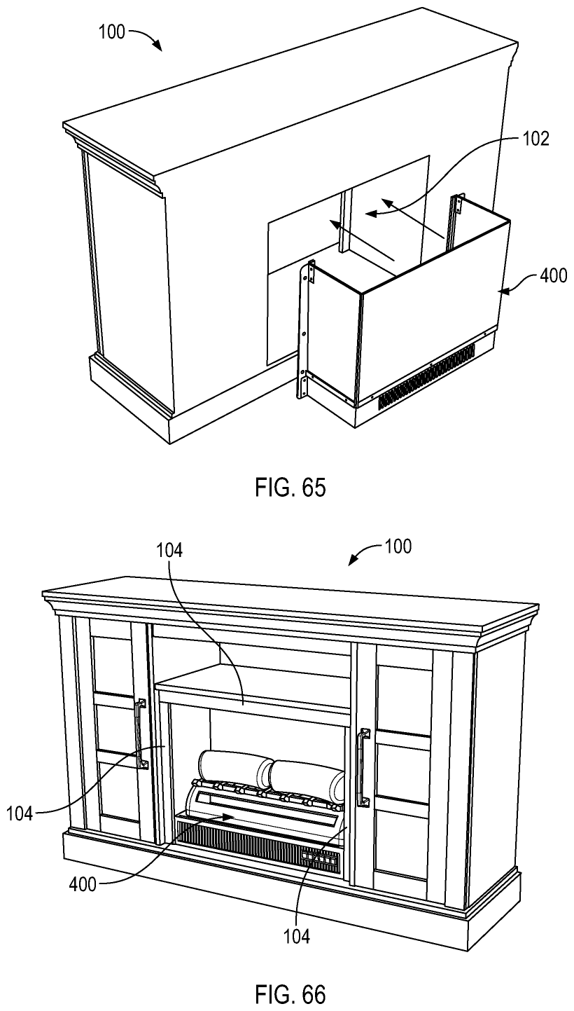

FIG. 59 illustrates assembly of the face frame/upright subassembly 408/410 to the foundation/heater 406 unit with 4 screws. FIG. 60 illustrates unpacking of the rear panel 404, folding and assembly with the foundation/heater unit 406 and uprights 410 with screws. FIG. 61 illustrates assembly of the log set 440 to the ember bed grate assembly 438. FIG. 62 illustrates placement and assembly of the ember bed log set assembly 412 with foundation unit/face frame subassembly and electrical connection of the firebed 412 with the heater unit controller 454 (USB 452). FIGS. 63-64 illustrate final insert kit assembly with insertion of the glass viewing panel 402 into the opposed glass channels 432 on the face frame 410. The lower edge of the glass panel 402 rests on/in the channel 413 in the upper surface of the foundation front edge. The assembled fireplace insert kit 400 is now ready for assembly with the previously assembled furniture console kit 100 as described hereabove. FIGS. 65-66 illustrate assembly of the completed fireplace insert kit 400 into the firebox cavity 102 in the furniture console 100 where the face frame 408 and uprights 410 are positioned in snug facing engagement with the back surface of the framing stiles 104. FIG. 66 illustrates the fully assembled and combined fireplace insert kit 400 and furniture console kit 100.

FIGS. 61-62 also illustrate an exemplary daisy chain connection of the log set 440 to the firebed unit 438 to the foundation/heater unit 408 and control 454 with USB connections 452.

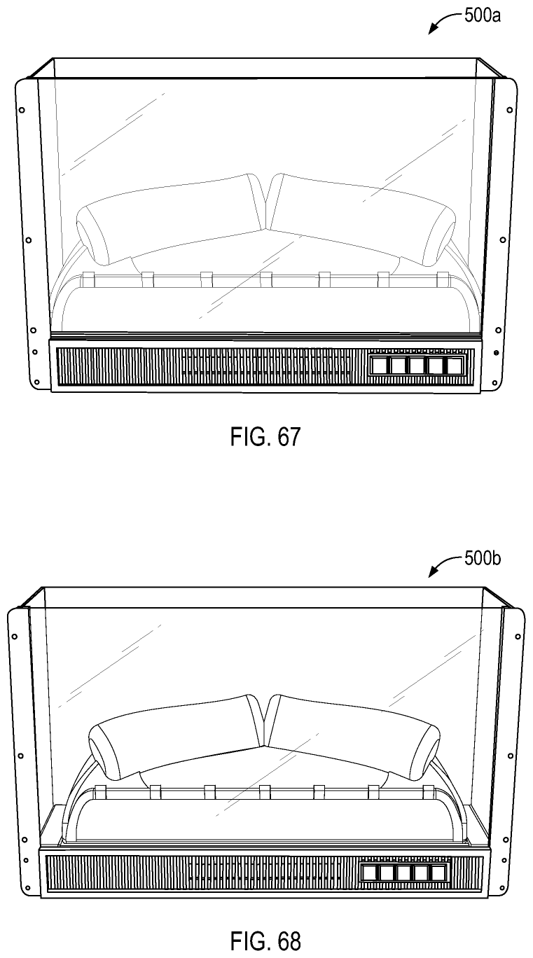

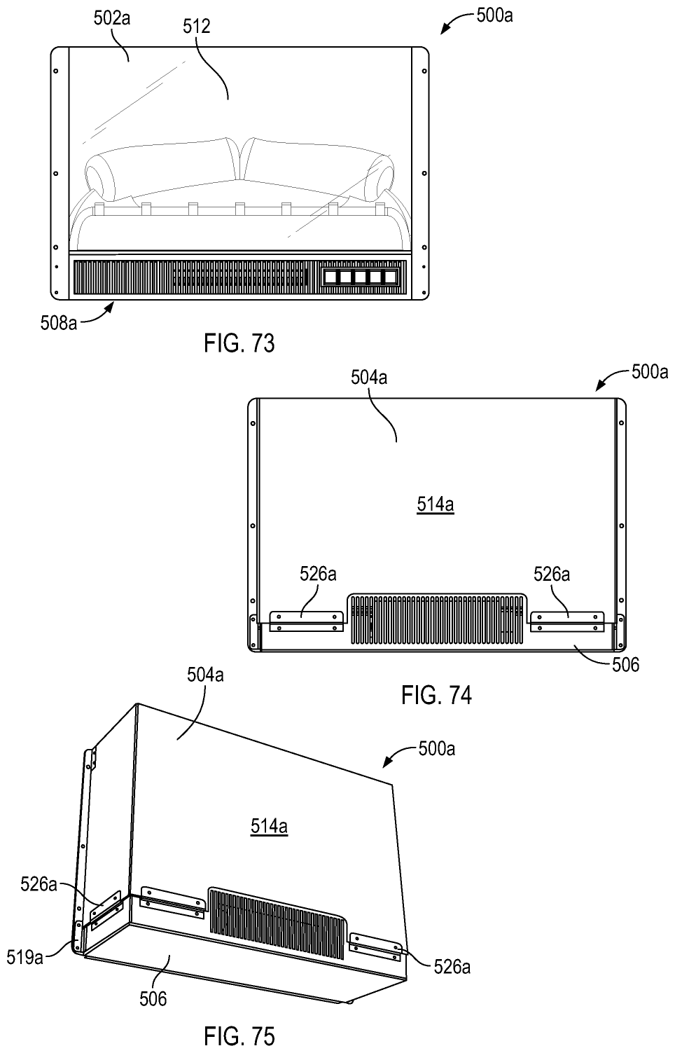

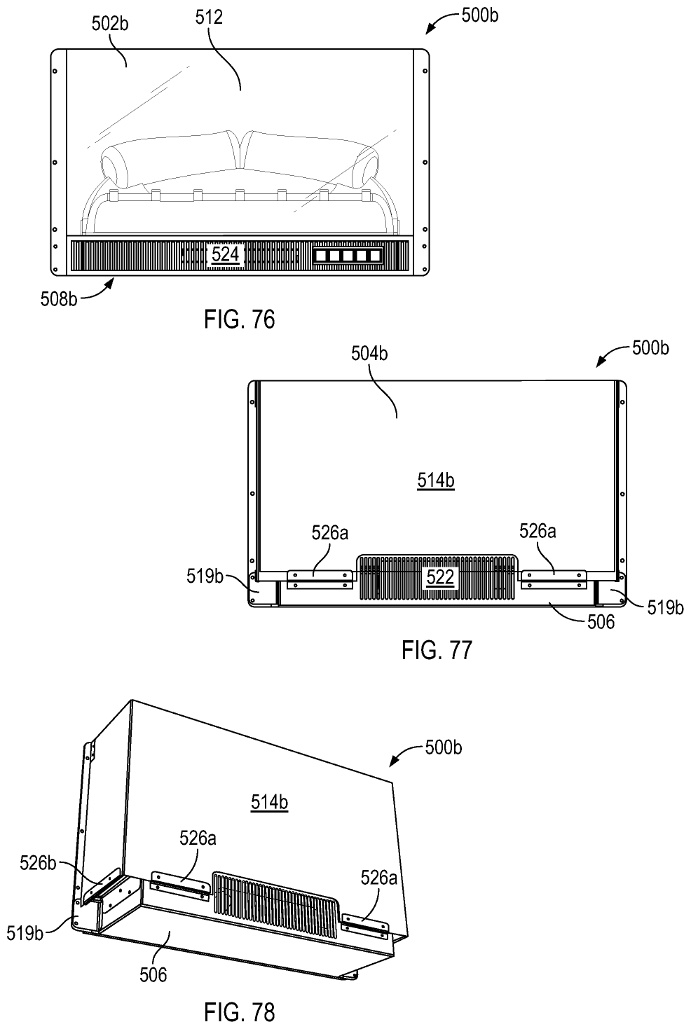

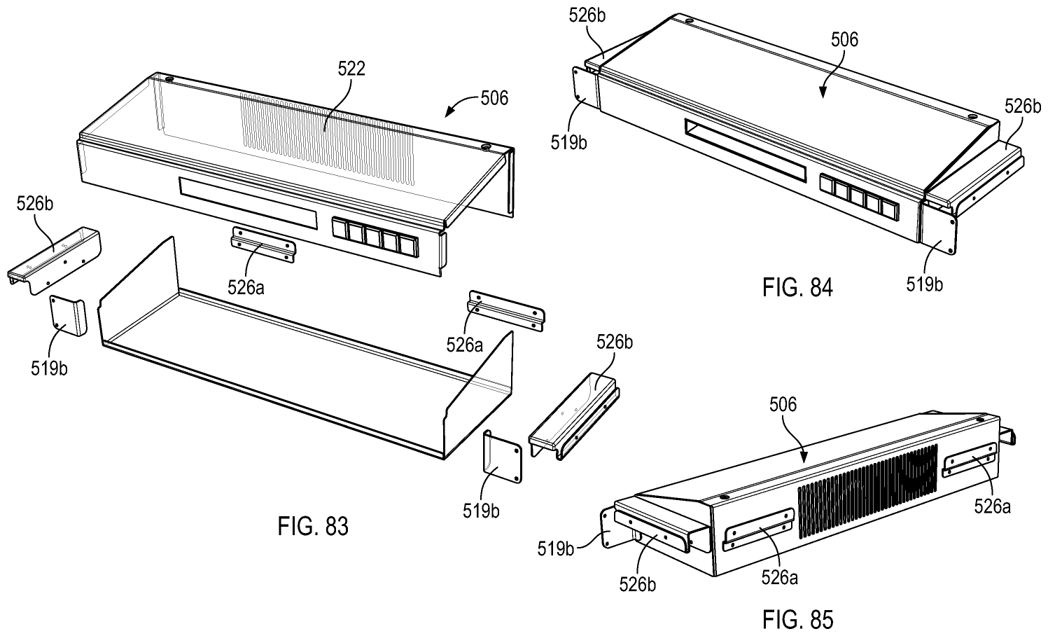

Turning to drawing FIGS. 67-91, an exemplary embodiment of a shared component insert kit system comprising two (or more) complementary ready to assemble simulated fireplace insert kits are illustrated.

Generally, a simulated fireplace insert system for constructing a plurality of simulated fireplace insert assemblies 500 of different widths 500A/500B using shared components comprises a shared foundation 506 having a front, a top, opposing left and right sides, and a rear, a first face frame/heater grill 508A having a first width and first second upright structural supports 510 removably secured or coupled to the face frame 508A and foundation 506 adjacent said front, a second face frame/heater grill 508B having a second width with first and second upright structural supports 510 removably secured or coupled to the face frame 508B and foundation 506 adjacent the front, a first firebox panel 504A having a rear imaging screen portion 514A having a first width and forwardly extending side portions 516A/518A, a second firebox panel 504B having a rear imaging screen portion 514B having a second width greater than said first width, and a forwardly extending side panel portions 516B/518B, a shared simulated firebed assembly 512, and foundation extension brackets 519.

The share component system may be utilized for construction of multiple different size inserts 500A/500B wherein the shared foundation 506 is assembled with the first face frame 508A, the first firebox panel 504A and simulated firebed assembly 512 to form a first simulated fireplace assembly 500A having a first width. The first face frame 508A may be fixed or removably secured to the foundation 506 and the simulated firebed 512 is received on the foundation 506. The first firebox panel 504A has a lower peripheral edge removably secured to the foundation 506, and the forwardly extending panel portions 516A/518A of the first firebox panel 504A engages the upright structural supports 510 whereby the foundation 506 and the upright structural supports 510 transfer structural rigidity to the first firebox panel 504A when assembled and fastened.

In an alternate configuration, the shared foundation 506 and extension brackets 519 may be assembled with the second face frame 508B, the second firebox panel 504B and the simulated firebed assembly 512 to form a second simulated fireplace assembly 500B having a second width. The second face frame 508B may be fixed or removably secured to the foundation 506 and extension brackets 519 while the simulated firebed 512 is received on the foundation 506. The second firebox panel 504B has lower peripheral edges removably secured to the foundation 506, and the forwardly extending panel portions 516B/518B of the second firebox panel 504B engage the upright structural supports 510 whereby the foundation 506 and the upright structural supports 510 transfer structural rigidity to the second firebox panel 504B when assembled and fastened.

At the core of the shared component system is the foundation unit 506 which may include a heater assembly 520 therein. The foundation/heater unit 506 is the most expensive component in the system, and by making this particular component common to the entire system, economies of scale of larger volume manufacturing may be employed. For example, to manufacture 100,000 23 inch units and 100,000 26 inch units would normally require 100,000 of each separately designed foundation unit. However, by employing the current system, the user may secure 200,000 of the same unit thereby significantly lowering costs. Similar economies of scale can be applied to other shared components, such as the firebed assembly 512, upright structural supports 510 and/or other brackets and panels.

Specifically, referring to the drawing Figures, it can be seen that the two kit versions 500A/500B are substantially similar in construction with the exception of the external width of the insert kits. FIGS. 67, 69, 71 and 73-75 represent a 23 inch insert 500A while FIGS. 68, 70, 72 and 76-78 represent a 26 inch insert 500B.

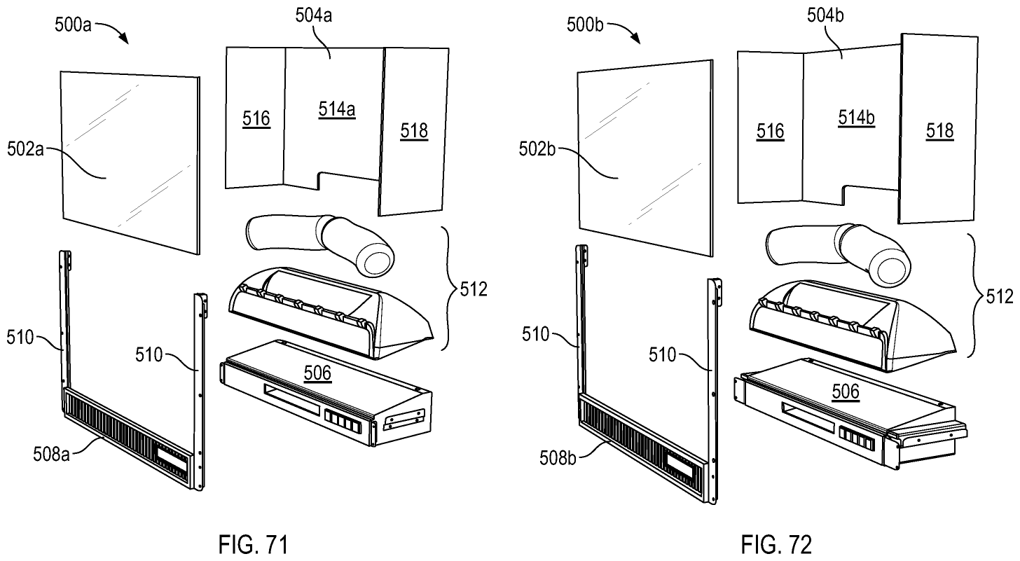

As best seen in FIGS. 71 and 72, the ready to assemble simulated electric fireplace insert kits 500 may be broken down into parts and subassemblies comprising a front glass panel 502A/502B, a firebox panel 504A/504B, a shared foundation/heater unit 506, a face frame 508A/508B which may include the upright structural supports 510, and a shared firebed/log set assembly 512.

While the shared parts include the foundation/heater unit 506, and firebed assembly 512, the non-shared parts may include the lower face frame grill portion 508A/508B, the viewing panels 502A/502B, the firebox panels 504A/504B, side channel lip brackets 526A/526B and face frame extender brackets 519.

The front glass panel 502 may be packed separate from the structural components so that it can be shipped separately in appropriate protective packaging. As best seen in FIGS. 71 and 72, the glass panel 502 is slightly wider in the 26 inch version 502B (FIG. 72) than in the 23 inch version 502A.

The firebox panel 504 has a rear imaging screen portion 514 and left and right side panel portions 516,518 to form the rear and sides of a decorative fireplace interior. Additionally, it should be clear that the rigid panel 504 also provides structural stability to the face frame 508 and uprights 510 when the unit 500 is assembled and the panel 504 is secured both to the foundation/heat unit 506 and to the face frame 508 and uprights 510.

The firebox panel 504 may comprise a rigid, planar panel substrate, such as an ⅛ inch MDF panel, and a decorative vinyl laminate surface film applied to the rigid panel substrate. The vinyl film may be printed with any of a variety of different fireplace interiors or may simply be colored black. It should be understood that other types of rigid panel materials may be used, such as metal, plastic, other wood materials, and the specific exemplary embodiments should not be considered limiting. Likewise, the decorative surface covering or film may comprise alternative materials and coverings, such as paint or other types of plastic, paper materials, films etc.

As seen in FIGS. 71 and 72, the imaging screen portion 514 of firebox panel 504 is slightly wider in the 26 inch version 514B (FIG. 72) than in the 23 inch version 514A (FIG. 71).

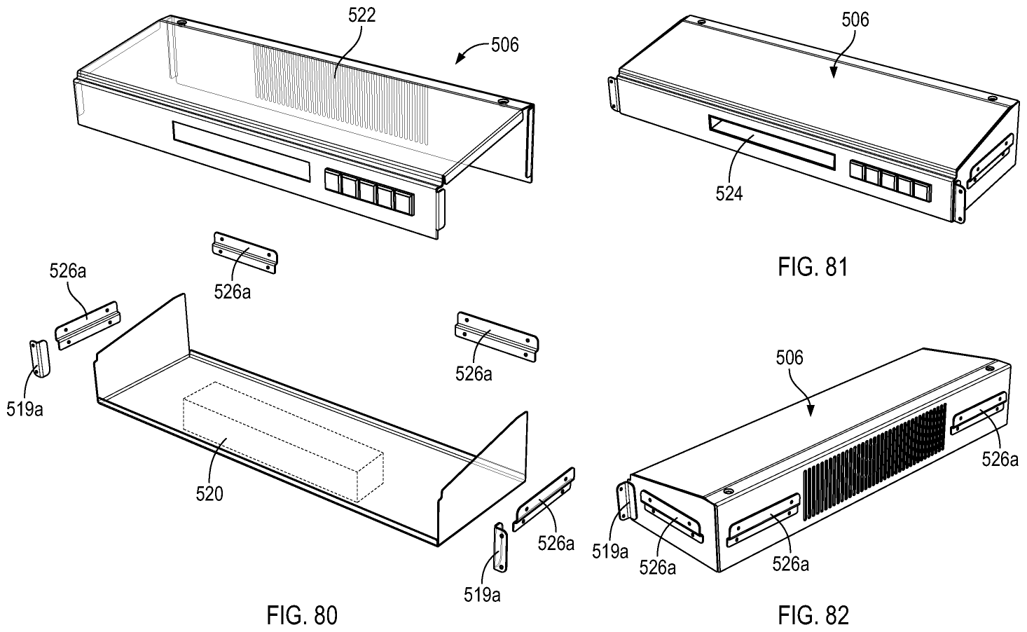

Referring to FIGS. 80-82 the core foundation/heater unit 506 is common to the system and may be constructed from several parts and may include a housing enclosing a heater assembly 520 (See FIG. 79). The housing has front, rear, top bottom, left and right sides. The front face and various other surfaces include intake 522 and exhaust 524 slots for heated air delivery through the front face. In FIGS. 75 and 80-82, the rear side of the foundation/heater unit as well as the left and right side edges thereof have upwardly facing lip channels or lip channel brackets 526A which receive the lower peripheral edges of the firebox panel 504 in the first 23 inch configuration 500A. Similarly, in FIGS. 78 and 83-85 (26 inch version), the lower peripheral edges of the wider firebox panel 504B are received into the rear lip channel brackets 526A while the sides are received into wider side lip channel brackets 526B secured to the sides of the foundation 506.

FIGS. 75 and 80-82, (23 inch version) further illustrate shorter left and right face frame tabs 519A for securing the face frame to the front of the foundation/heater unit, while FIGS. 78 and 83-85 (26 inch version) illustrate wider left and right face frame tabs 519B.

The face frames 508 each comprises a face panel or grill with an upper edge surface and may include fixed or removable left and right upright structural supports 510 substantially as described in FIGS. 31-36 and/or the embodiment in FIGS. 37-66. The face frame portions 508 are identical except for width.

Referring to FIGS. 79 and 86-91, the firebed 512 in the illustrated example comprises an ember bed grate assembly 538 configured and arranged for assembled positioning on the top surface of the foundation/heater unit 506 in front of the firebox panel 504. The ember bed and grate 538 simulate a conventional wood fireplace. However, it is equally contemplated that the firebed may comprise other forms of simulated firebeds such a river rock or crystal stones.

The figures illustrate an exemplary ember bed and grate assembly 538 and log set 540 which can be shared and utilized by both the 23 inch and 26 inch embodiments. The ember bed and grate assembly 538 includes a housing portion which enclosed a simulated electronic fire simulating device 542 as generally known in the art (see description hereinabove for FIG. 10). Typically, such as device 542 may include an LED light bar 544, flicker rod 546, reflector 548 and a flame screen 550 which will project glowing and flickering light throughout the embed bed and through the flame screen onto the imaging wall portion 514 of the firebox panel 504.

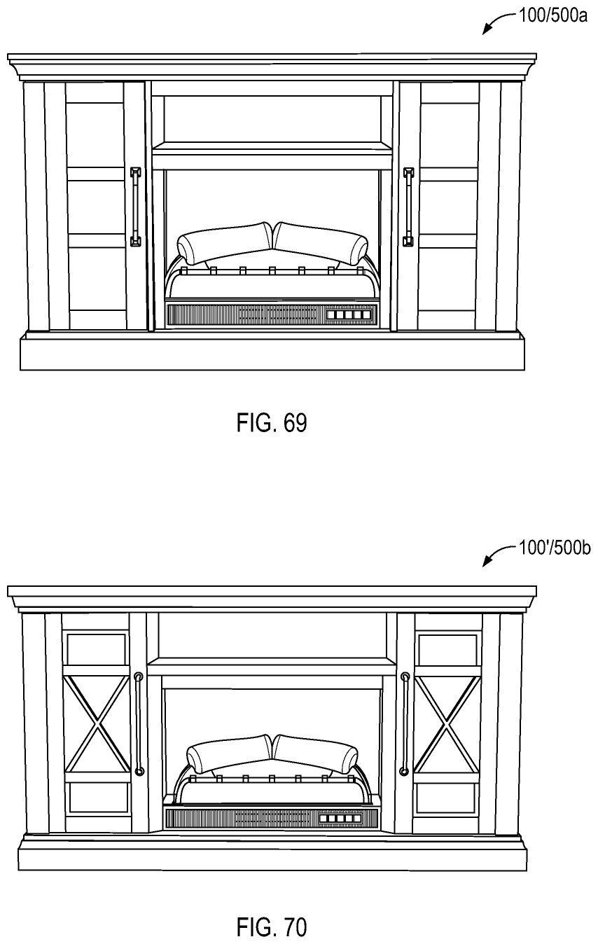

FIGS. 69 and 70 are artistic renderings of the respective 23 inch and 26 inch insert kits 500A/500B assembled with respective furniture console kits 100A and 100B.

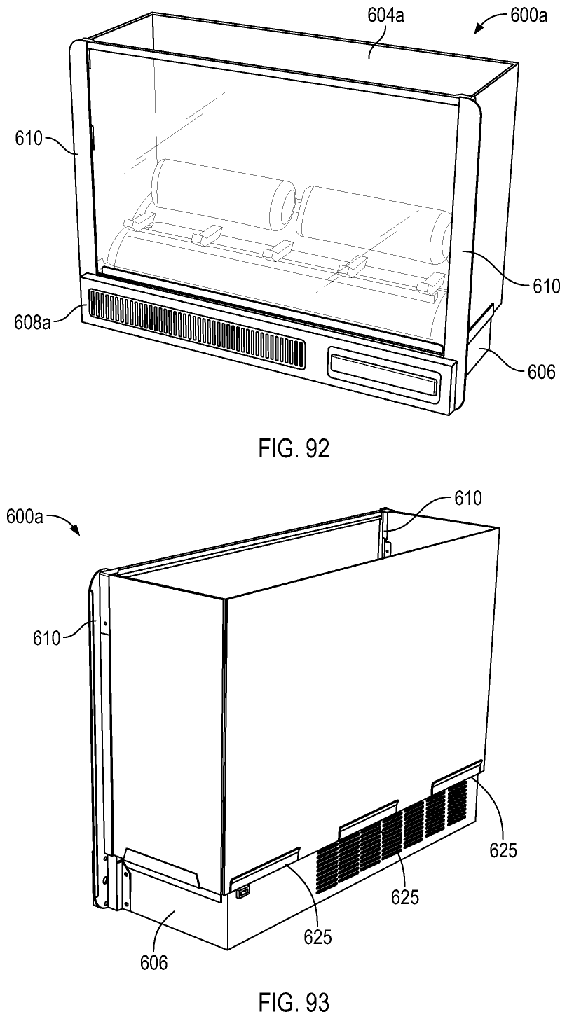

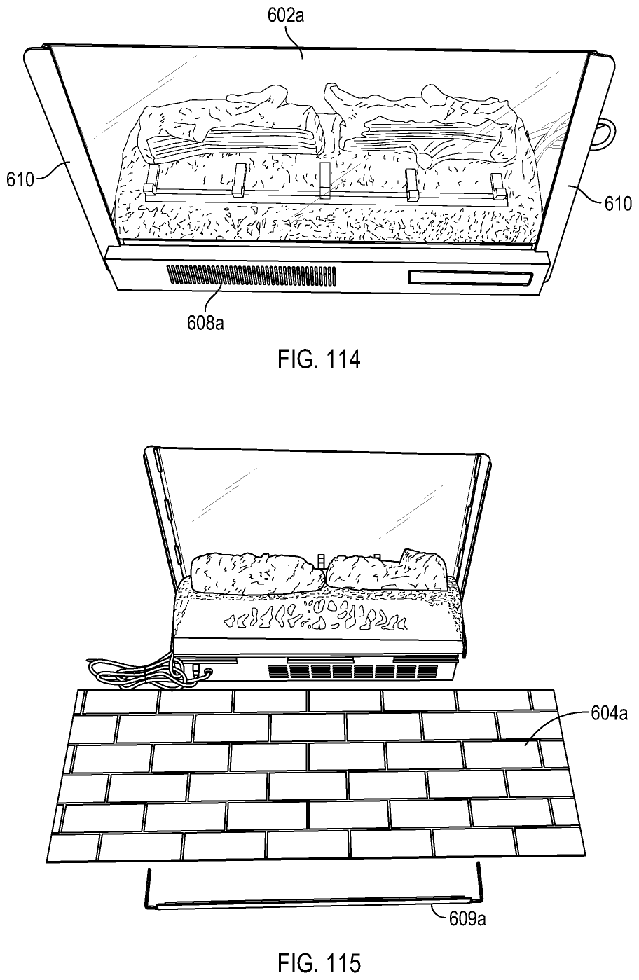

Turning to FIGS. 92-118 there is illustrated another exemplary embodiment 600 of a simulated fireplace insert system for constructing a plurality of simulated fireplace insert assemblies 600A/600B/600C of different widths using shared components.

The present exemplary embodiment 600 comprises a shared foundation 606 having a front, a top, opposing left and right sides, and a rear, and shared first and second upright structural supports 610 each having a lower end removably secured or coupled to the foundation 606 adjacent the front. The system further comprises first, second and third viewing panels 602A/602B/602C each having respective first second and third widths, first, second and third firebox panels 604A/604B/604C each having a rear imaging screen portion 614A/614B/614C with respective first, second and third widths and forwardly extending side portions 616/618, first second and third simulated firebed assemblies 612A/612B/612C having first second and third widths, first second, and third horizontal structural supports 609A/609B/609C each respectively having first second and third widths, first and second pairs of upright support extension brackets 619B/619C, and first, second and third pairs of side channel brackets 626A/626B/626C.

The exemplary system may be utilized for construction of multiple different size inserts wherein the shared foundation 606 and upright structural supports 610 are assembled in a first configuration (A components) with the first firebox panel 602A and the first simulated firebed assembly 612A to form a first simulated fireplace assembly 600A having a first width, the first and second upright supports 610 removably secured to the foundation 600, the first simulated firebed 612A received on the foundation 606, the first firebox panel 604A having a lower peripheral edge removably secured to the foundation 606, the forwardly extending panel portions of the first firebox panel 604A engaging the upright structural supports 610 whereby the foundation and the upright structural supports transfer structural rigidity to the first firebox panel, and the viewing panel 602A received between the upright supports 610.

Second and third configurations 600B and 600C utilize the respective second and third unique components (B and C components) with the shared foundation 606 and upright structural support arms 610 to create the second and third assembled units 600B and 600C as illustrated.

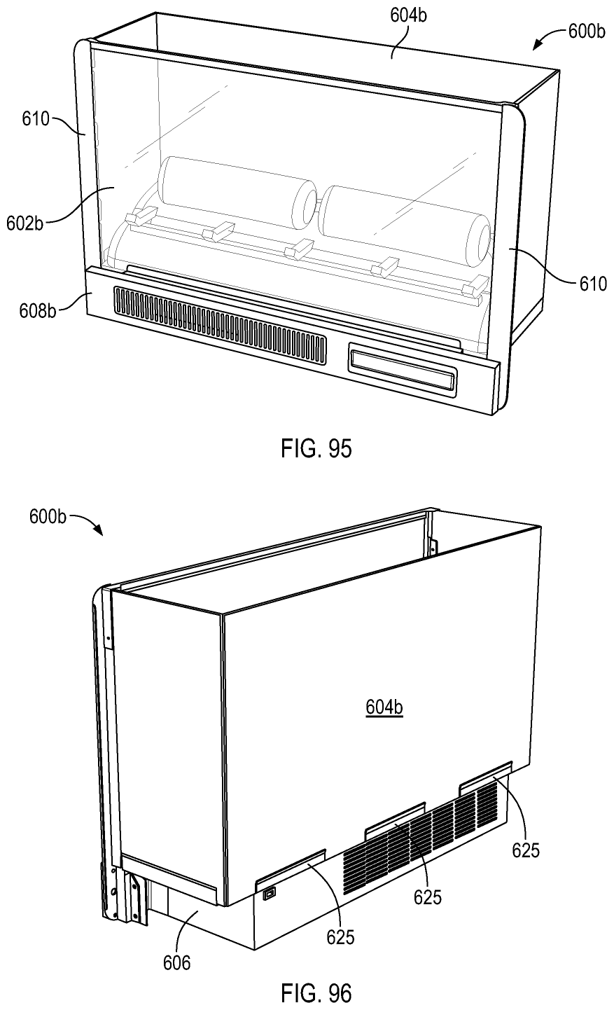

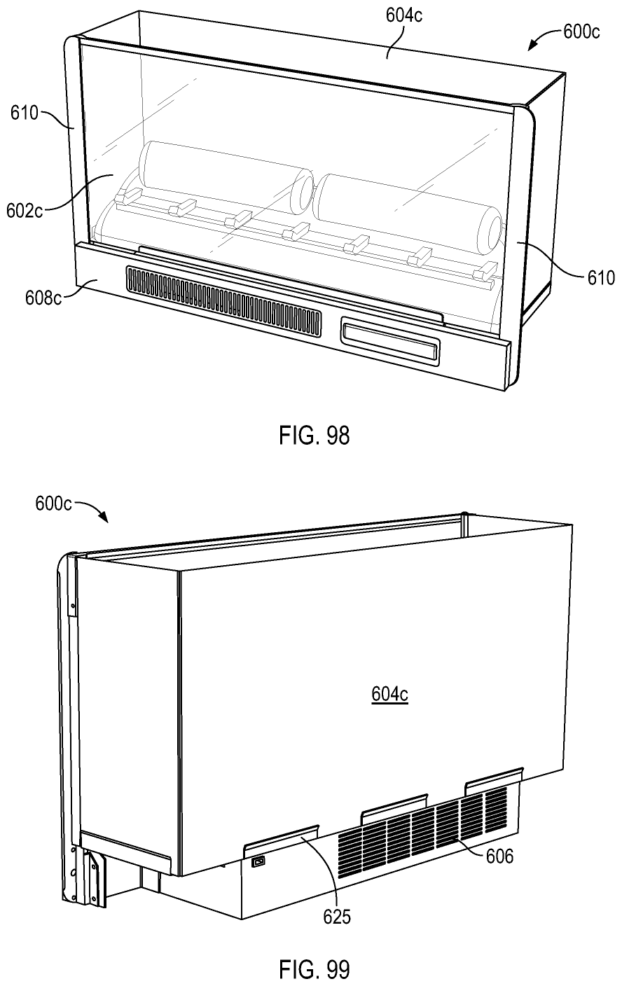

Referring to the drawing Figures, there are three different kit versions which substantially similar in construction with the exception of the external width of the kits. FIGS. 92-94 represent a 23 inch insert 600A, FIGS. 95-97 represent a 26 inch insert kit 600B and FIGS. 98-102 represent a 30 inch kit 600C.

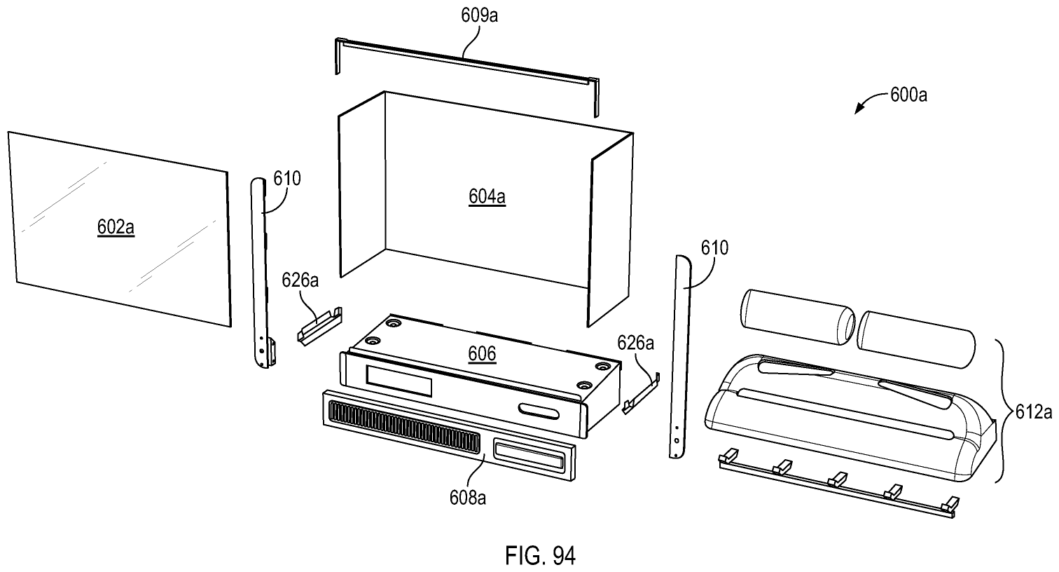

As best seen in FIGS. 94, 97 and 100, the ready to assemble simulated electric fireplace insert kits may be broken down into parts and subassemblies comprising a front viewing panel 600, a viewing panel 602, a firebox panel 604, a shared foundation/heater unit 606, a face frame 608, shared upright structural supports 610, firebox panel channel brackets 626, face frame extender brackets 619, horizontal structural connectors 609 for the upright supports, and a firebed/log set assembly 612.

The shared parts include the foundation/heater unit 606 and the upright structural supports 610. Otherwise, each configuration uses unique sizes of the non-shared parts which may include the lower face frame grill 608, the viewing panels 602, the firebox panels 604, face frame extender brackets 619, side channel brackets 626 and firebed assemblies 612.

The viewing panel 602, which may be glass or mesh, may be separated from the structural components so that it can be shipped separately in appropriate protective packaging. As best seen in FIGS. 94, 97 and 100, the viewing panels 602A/602B/602C differ in size to accommodate the define width of the kit.

Further, the viewing panels 602 may be excluded from the kit 600 whereby the front of the insert will be open.

The firebox panel 604 has a rear imaging screen portion 614 and left and right side panel portions 616/618 to form the rear and sides of a decorative fireplace interior. Additionally, it should be clear that the rigid panel 604 also provides structural stability to the upright supports 610 when the unit is assembled and the panel 604 is secured both to the foundation/heat unit 606 and to the uprights 610.

The firebox panel 604 may comprise a rigid, planar panel substrate, such as an ⅛ inch MDF panel, and a decorative vinyl laminate surface film applied to the rigid panel substrate. The vinyl film may be printed with any of a variety of different fireplace interiors or may simply be colored black. It should be understood that other types of rigid panel materials may be used, such as metal, plastic, other wood materials, and the specific exemplary embodiments should not be considered limiting. Likewise, the decorative surface covering or film may comprise alternative materials and coverings, such as paint or other types of plastic, paper materials, films etc. As seen in FIGS. 94, 97 and 100, the firebox panels differ in size to accommodate the defined width of the kit.

The firebed/log set assemblies 612 in the exemplary embodiments comprise an ember bed/grate 638 and log set 640 assembly configured and arranged for assembled positioning on the top surface of the foundation unit 606 in front of the firebox panel 604. The firebed assembly 612 is intended to simulate the look of a conventional wood fireplace. However, it is equally contemplated that the firebed 612 may comprise other forms of simulated firebeds such a river rock or crystal stones.

While the firebed 512 in the prior described exemplary system was shared, the present shared component system illustrates first, second and third exemplary firebed assemblies 612A/612B/612C which are sized to accommodate the defined width of the unit. Other than width, the construction of the firebed assemblies 612 is substantially similar. The firebed assemblies 612 each include a housing portion which encloses a simulated electronic fire simulating device 642 as generally known in the art (see description hereinabove for FIG. 10). Typically, such as device 642 may include an LED light bar, flicker rod and a flame screen which will project glowing and flickering light throughout the embed bed and through the flame screen onto the imaging screen portion of the firebox panel.

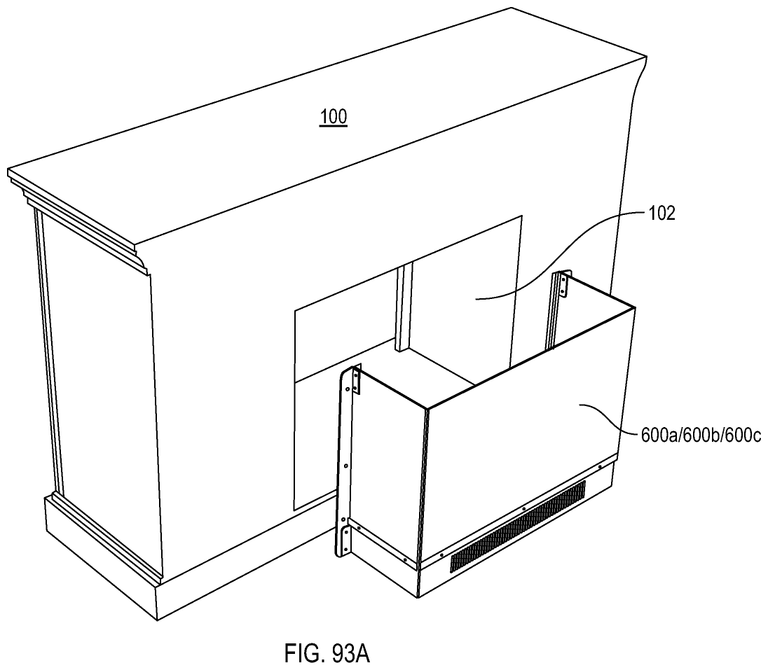

Like the previous embodiment, the core foundation/heater unit 606 is common to the entire system and may be constructed from several parts and may include a housing enclosing a heater assembly and having a front, top, opposing left and right sides and a rear surface. The front and rear faces and various other surfaces may include intake and exhaust slots 622/624 for heated air delivery through the front. As best seen in FIGS. 93. 96, 99 and 101, the rear surface of the foundation/heater unit thereof has integrated upwardly facing lip channels 625 which may receive the lower peripheral edge of the imaging screen portion 614 decorative firebox panel 604 in all three configurations.

While illustrated with lip channels 626, other methods of securing the firebox panel 604 to the foundation 606 are also contemplated, such as for example, where the panel 604 may be secured within the channels 626 with fasteners as illustrated in other embodiments or may be secured with fasteners directly to wall of the foundation 606.

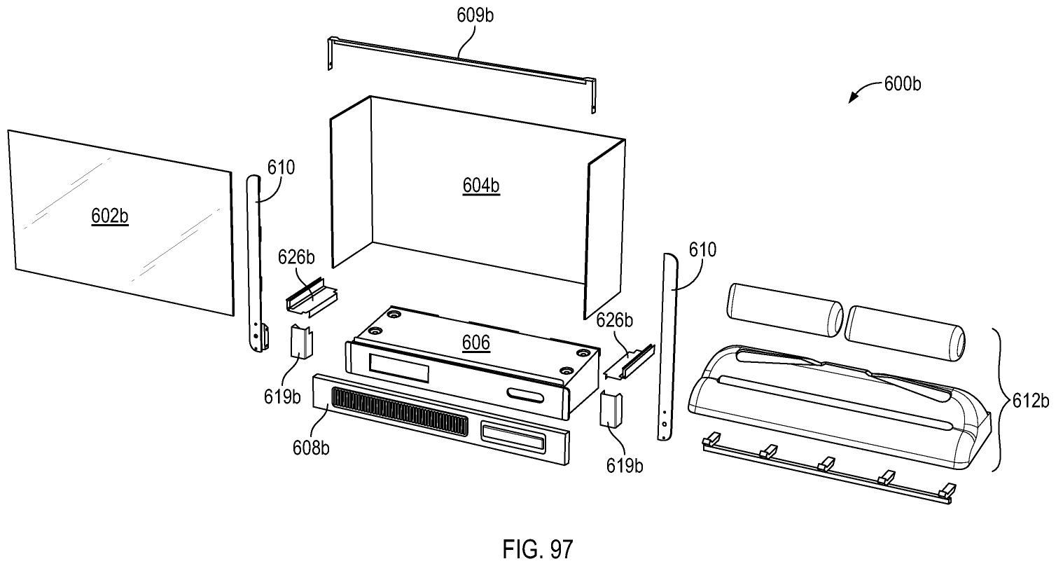

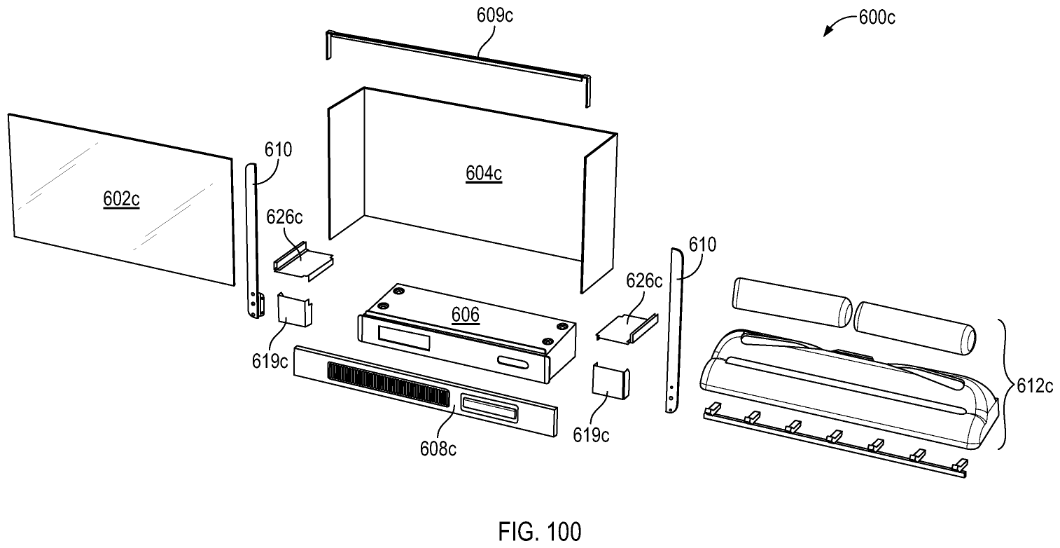

The present system includes first second and third face frames/grills 608A/608B/608C each respectively have first, second and third widths to accommodate the defined width of the respective unit (FIGS. 94, 97 and 100). The face frames 608 are configured substantially as described hereinabove in FIGS. 31-36 with the exception that the left and upright structural supports 610 are not welded to the face frames 608 as previously described. Rather, these left and right upright structural supports 610 are now a shared component that is removably secured to front and sides of the foundation housing (23 inch—FIG. 94), or alternatively, coupled to the front of the foundation by means of opposing pairs of extender brackets 619 secured to the foundation (see 619B 26 inch— FIG. 97) (see 619C 30 inch— FIG. 100).

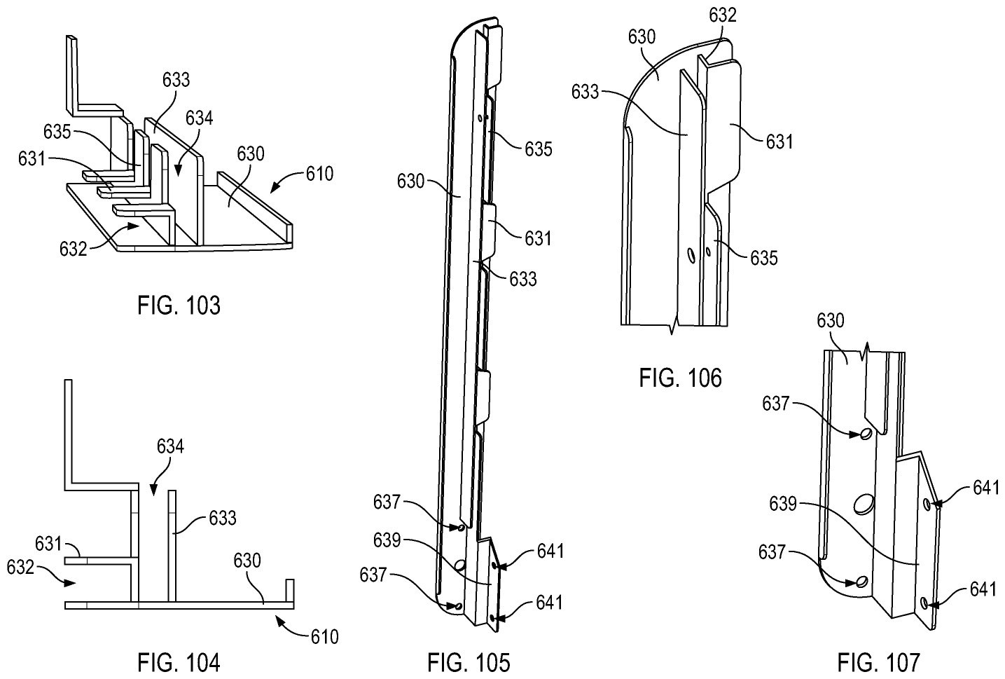

Referring to FIGS. 103-107, the shared left and right upright structural supports 610 have connection elements substantially as described in FIGS. 14-22. 31-36 and/or the embodiment in FIGS. 37-66. Each of the upright structural supports 610 has a main flat body portion 630 which provides a mounting surface and further has an inwardly facing elongated glass channel 632 formed by the flat body portion 630 and a plurality of spaced inward extending tabs 631 for receiving the viewing panel 602 therebetween. Each of the upright supports 610 further has a rearwardly facing channel 634 extending along the length of the body portion 630 formed by a flange 633 and plurality of rearwardly extending tabs 635 for receiving the firebox panel 604. The exact positioning of the channel tabs may be altered in various embodiments of the uprights 610 and may be located along the entire length, towards the center or bottom or may be in multiple locations. Other methods for securing the firebox panel 604 to the foundation 606 and uprights 610 are also contemplated. Fasteners may be inserted through aligned openings in the tabs and channel lips, such as illustrated in FIGS. 45-48.

The bottom end of each structural support 610 includes openings 637 for securing the body portion of the support 610 to the respective face frame 608 in each respective configuration. Further, the bottom ends each include a rearward perpendicular flange 639 with openings 641 which provide mounting points for securing the supports 610 to the side of the foundation 606 (23 inch— FIG. 94) or alternatively to the opposing pairs of extender brackets 619 secured to the foundation 606 (see 26 inch— FIG. 97) (see 30 inch— FIG. 100). The perpendicular arrangement of the securing points provides a rigid upright connection which is resistant to racking once secured.

The present shared component system also includes first, second and third pairs of side channel brackets 626A/626B/626C which are secured to the left and right sides of the foundation 606 to receive the lower peripheral edges of the forwardly extending portions 616/618 of the firebox panel 604 (see FIGS. 94, 97 and 100).

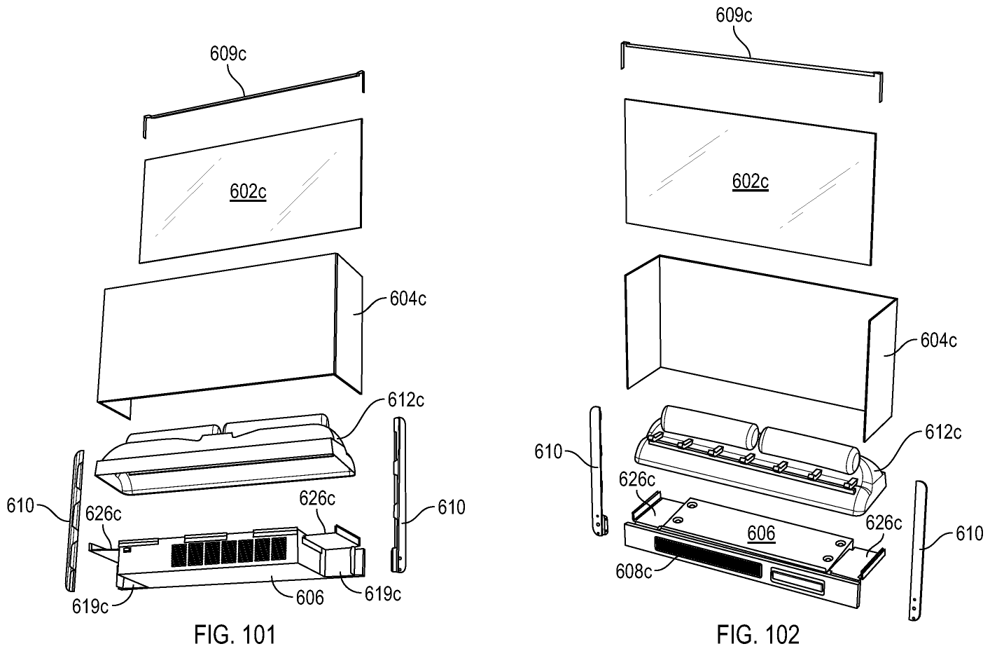

Referring to FIGS. 101 and 102, to simplify assembly for the end user, several of the components may be pre-assembled to the foundation 606. FIGS. 101 and 102 illustrate the components of the kit as will be encountered by the end user when unpacking the insert kit. The illustrated exemplar shows the 30 inch kit assembly 600C wherein the 30 inch face frame/grill 308C, respective extender brackets 619C and respective side channel brackets 626C are pre-assembled with the foundation 606.

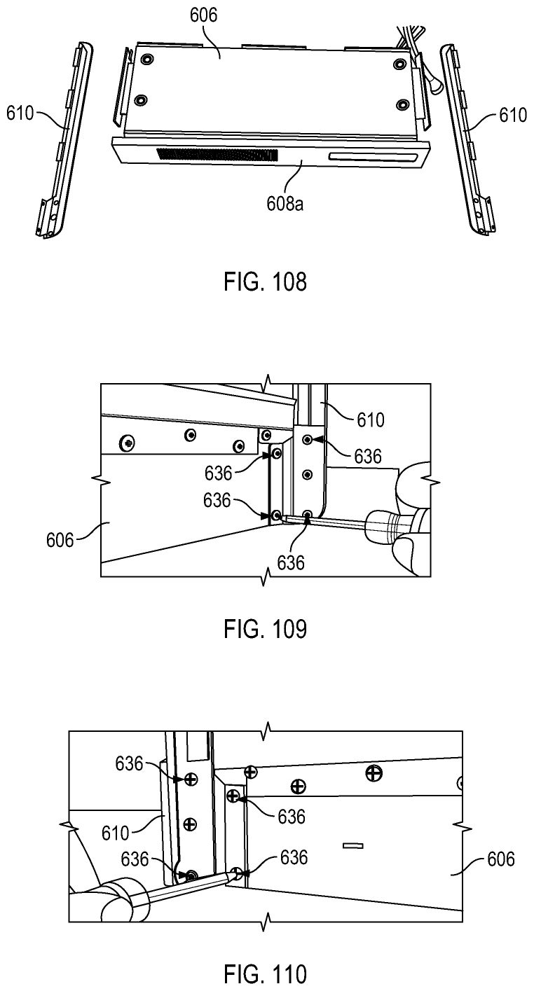

Turning now to FIGS. 108-118, stepwise assembly of an exemplary 23 inch fireplace insert kit 600A (FIGS. 92-94) is illustrated.

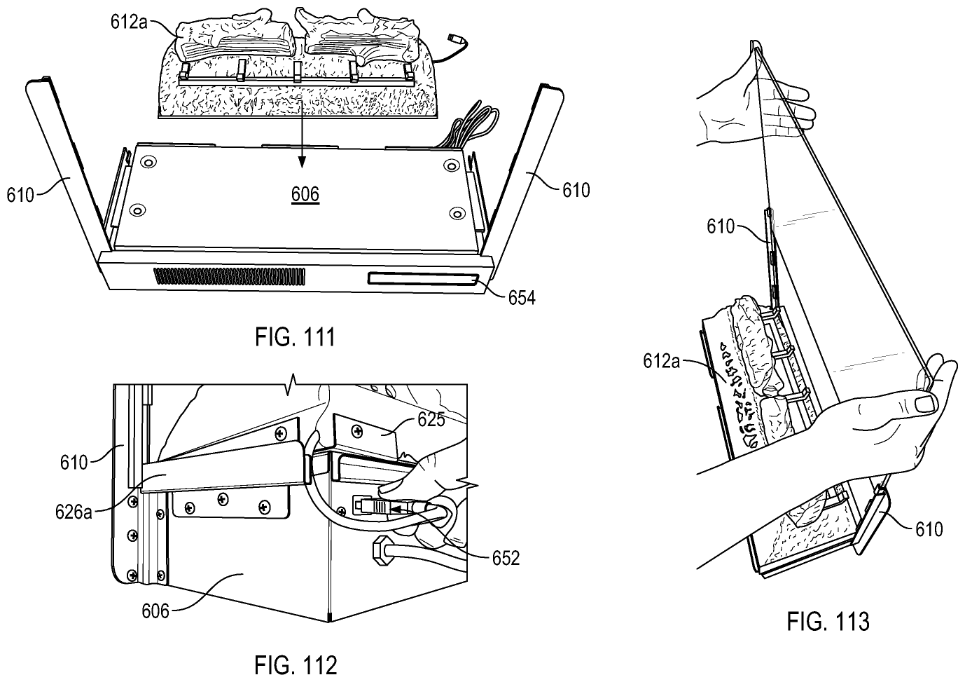

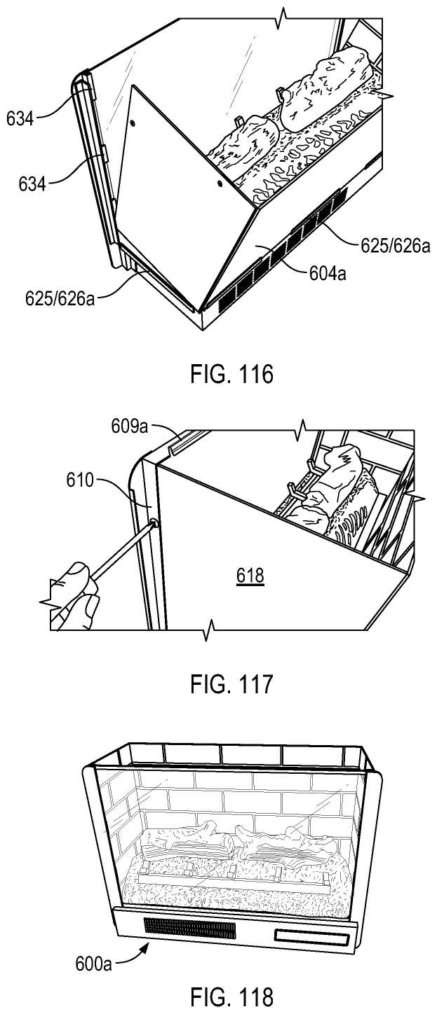

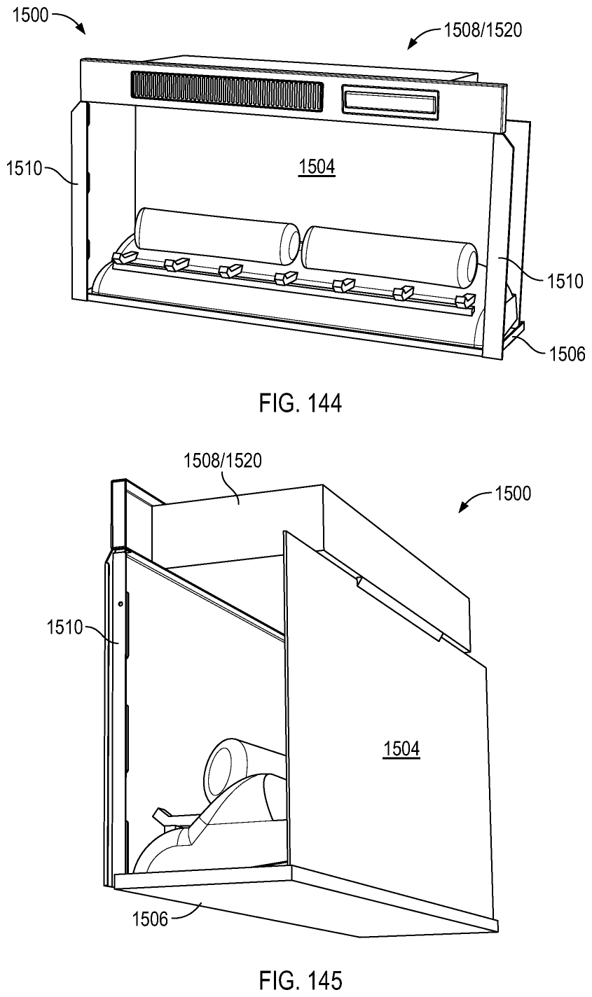

FIGS. 108-110 illustrate securing the left and right upright structural supports 610 to the foundation/heater unit 606 with four fasteners. FIGS. 111 and 112 illustrate placement of the firebed assembly 612C onto the top surface of the foundation/heater 606 and connection of the electronic components to the heater/controller 654 by means of a USB plug 652 in the rear of the foundation. FIGS. 113 and 144 illustrate assembly of the viewing panel 602C with the foundation/upright/firebed subassembly by sliding of the panel 602C downward in the vertical support channels 632. FIGS. 115 and 116 illustrate folding of the firebox panel 604C and insertion of the bottom peripheral edges thereof into the lip channels 625 on the foundation 606 and side brackets 626C and the forward peripheral edges into the rearward support channels 634 in the upright supports 610. FIG. 117 illustrates assembly of the horizontal structural support 609C across the top of the viewing panel 602C and into the outer flanges of the supports 610. A fastener passes through the downward arm of the horizontal structural support 609C, through the channel flange 633 and through the peripheral edge of the firebox panel 604C to secure the entire assembly into a rigid stable box construction. The insert box construction 600A/600B/600C may then be slidably inserted into the insert cavity of any suitable furniture piece 100 (See FIG. 93A).

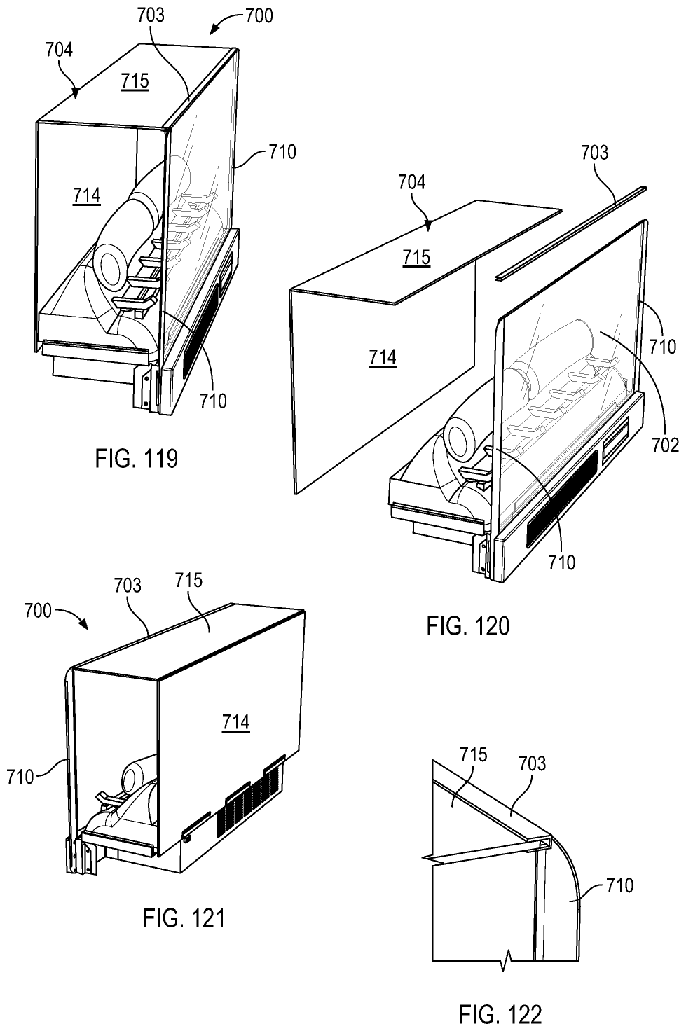

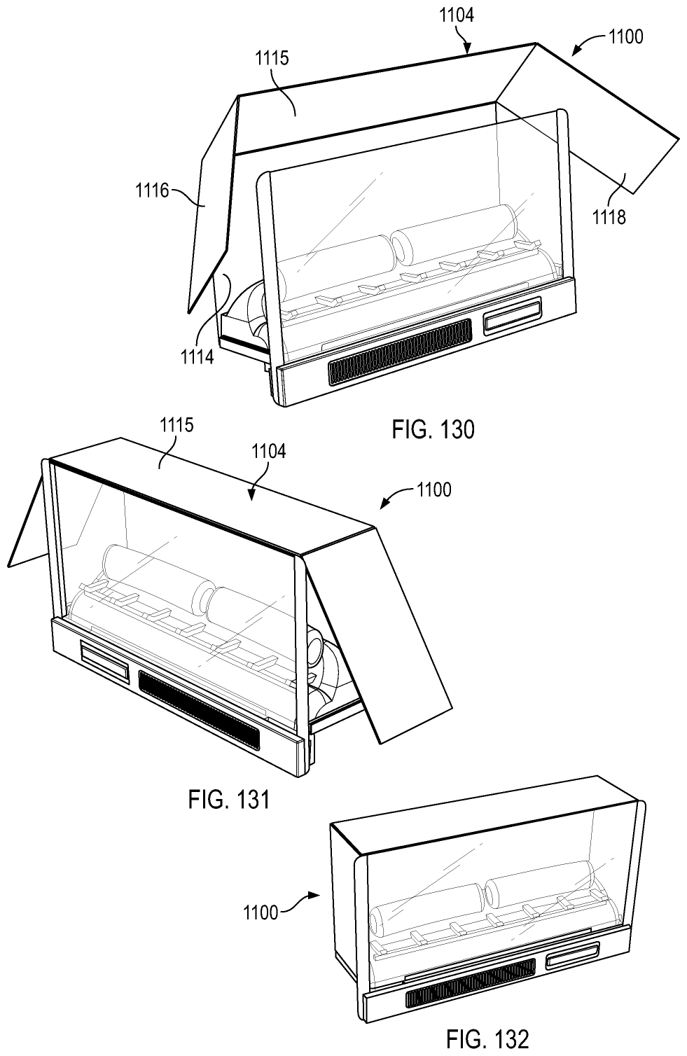

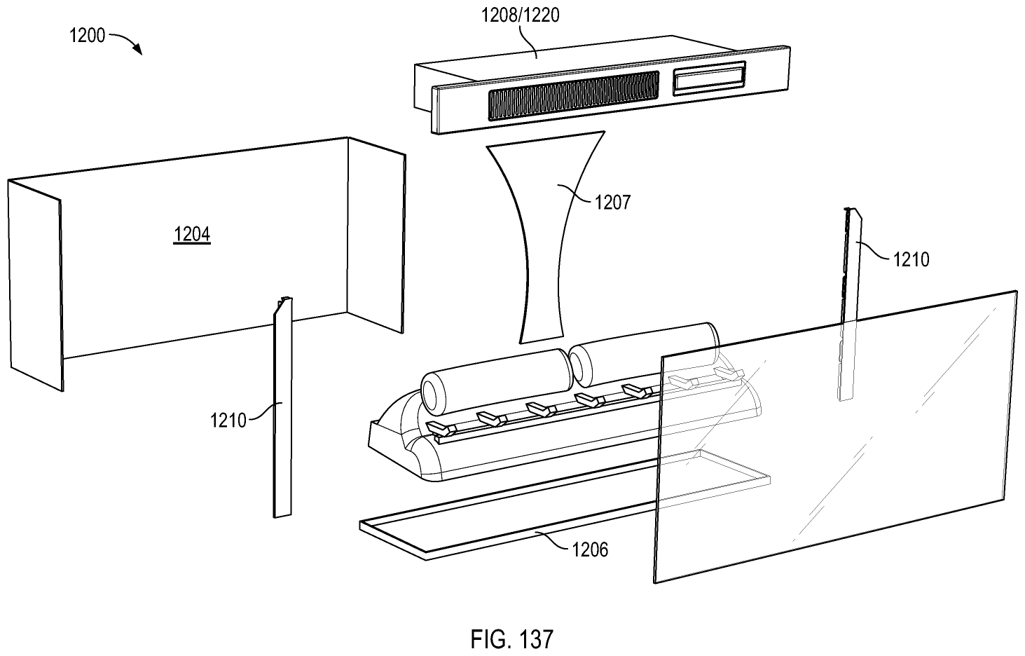

The following embodiments in FIGS. 119-156 illustrate various kits, shared components and unique components that are consistent with the previously described foundation, firebed, firebox panel, front face/grill and upright supports, and other kit components, and while the individual component parts may not be called out specifically, like illustrated parts may have the same structural features and functions as previously described. These embodiments will be distinguished to the extent that the embodiments comprise alternative structural components which may achieve similar or alternate end results.

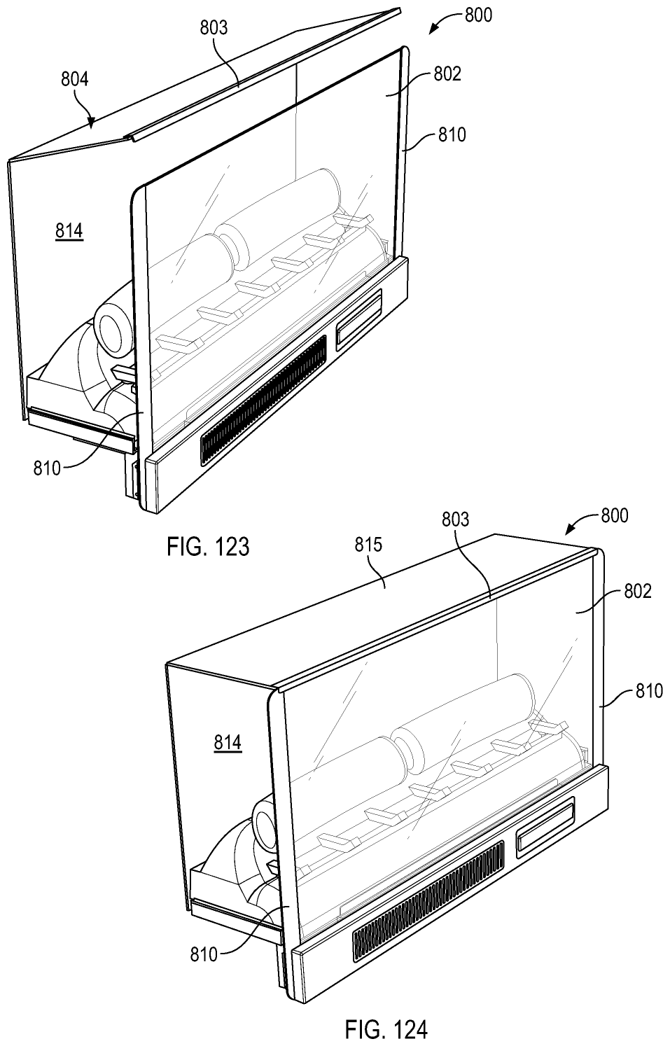

FIGS. 119-122 illustrate an exemplary simulated fireplace insert kit 700 where the firebox panel 704 has a rear imaging screen 714 with a forwardly extending top portion 715 with rigid panel edge support 703. The panel edge support 703 may be supported on top of the rearwardly extending flanges on the upright structural support arms 710 (FIG. 122). To the extent that the sides of the firebox are not defined, the interior sidewalls of a corresponding furniture kit 100 may provide complementary firebox illustrations to complete the firebox.

FIGS. 123 and 124 illustrate another exemplary simulated fireplace insert kit 800 where the firebox panel 804 has a rear imaging screen portion 814 and a top portion 815 with an L-shaped panel edge support 803 having a front flange portion which may be received over the viewing panel 802 and top of the upright supports 810. To the extent that the sides of the firebox are not defined, the interior sidewalls of a corresponding furniture kit 100 may provide complementary firebox illustrations to complete the firebox.

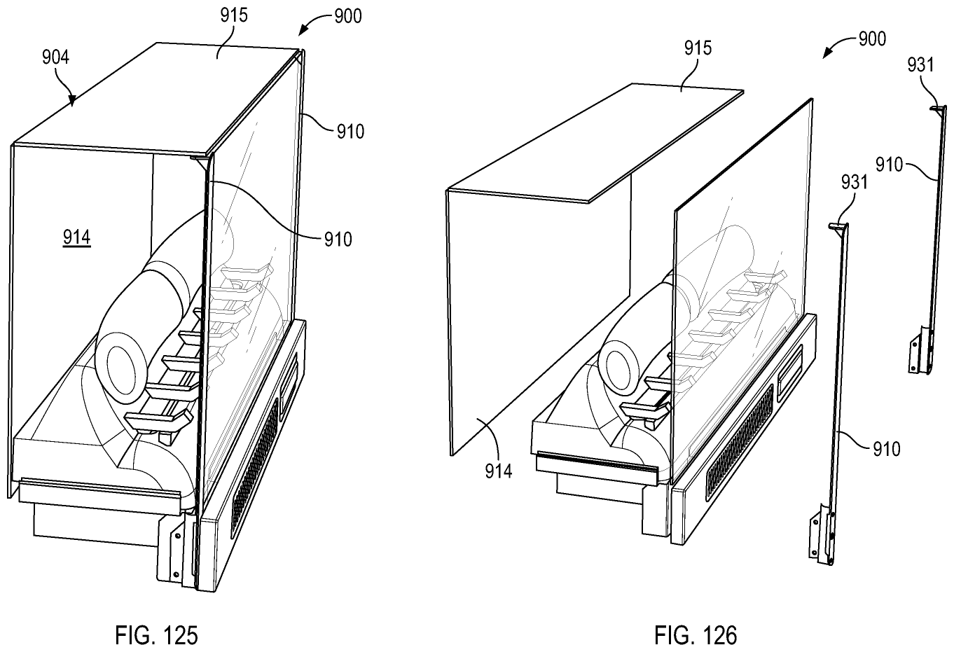

FIGS. 125 and 126 illustrate another exemplary simulated fireplace insert kit 900 where the firebox panel 904 has a rear imaging screen portion 914 and a top portion 915 and the upright structural supports 910 include a rearwardly extending support tab 931. The forward peripheral edge of the top 915 may be received and supported on and/or secured into the support tabs 931 by fasteners. To the extent that the sides of the firebox are not defined, the interior sidewalls of a corresponding furniture kit may provide complementary firebox illustrations to complete the firebox.

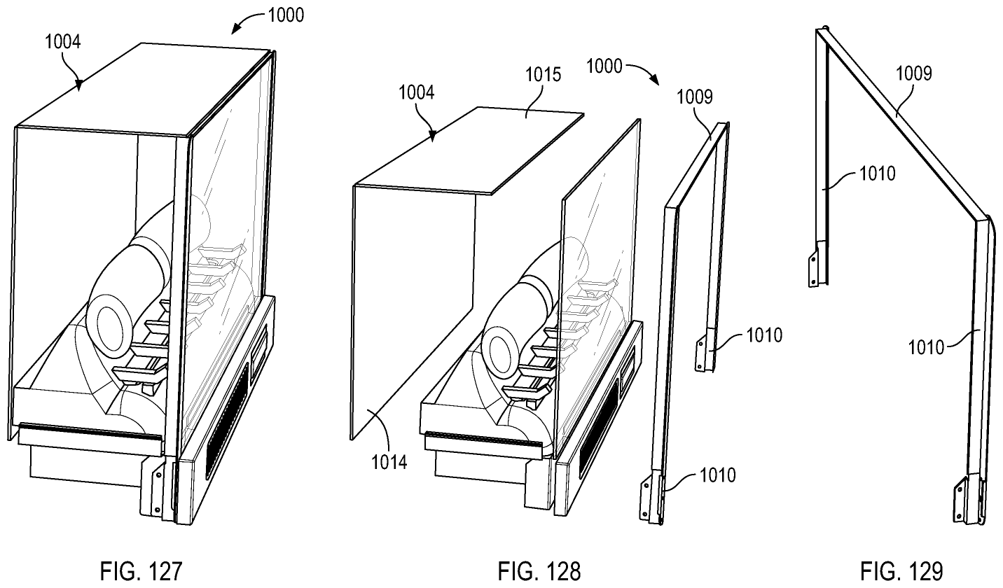

FIGS. 127-129 illustrate still another exemplary simulated fireplace insert kit 1000 where the firebox panel 1004 has a rear imaging screen portion 1014 and a top portion 1015 and the upright structural supports 1010 are integrally formed as a C-shaped frame joined at the top by a structural connector 1009. The frame 1009/1010 has a rearwardly extending flange and the forward edge of the top firebox panel portion 1015 may be received and supported on the flange and/or may be secured to the flange with fasteners. To the extent that the sides of the firebox are not defined, the interior sidewalls of a corresponding furniture kit may provide complementary firebox illustrations to complete the firebox.

FIGS. 130-132 illustrate an exemplary simulated fireplace insert kit 1100 where the firebox panel 1104 has a rear imaging screen portion 1114, a top portion 1115 and side portions 1116/1118 extending down from the top portion.

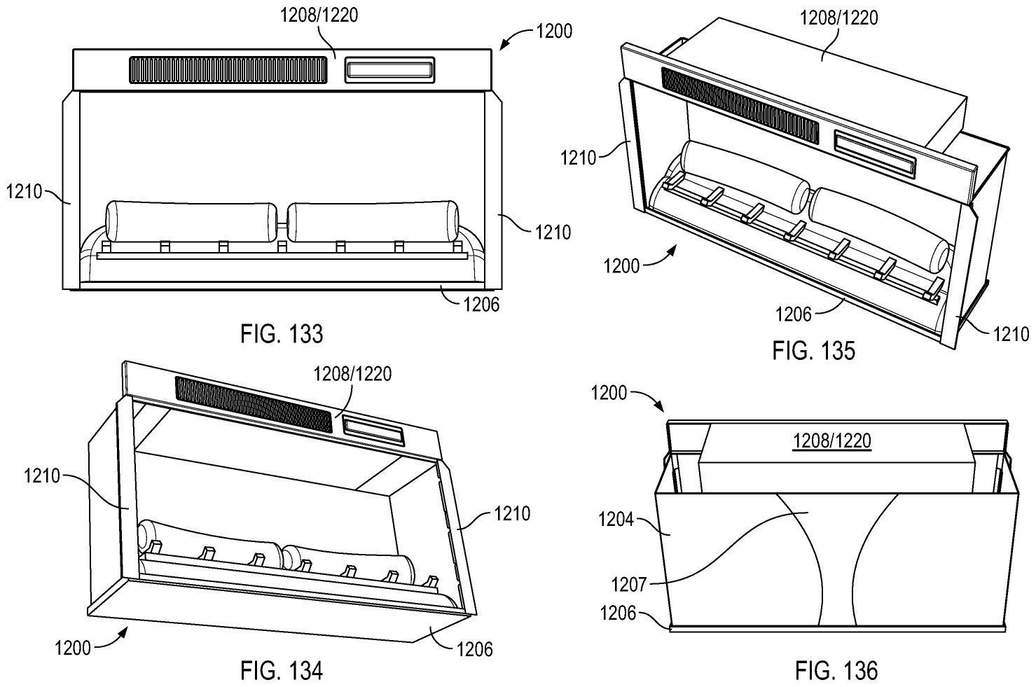

FIGS. 133-137 illustrate an exemplary simulated fireplace insert kit 1200 where the heater/face frame/grill assembly 1208/1220 is moved to the top of the assembly. The foundation 1206 in this embodiment may comprise a simplified frame having front, rear, and opposing sides, and may be in the form of an open box frame or may have top and bottom surfaces. The upright structural supports 1210 may be secured to the foundation 1206 by welding and/or other removable fasteners consistent with a kit assembly which may be flat packed. The firebox panel 1204 may be secured to the rear and sides of the foundation 1206 and the heater/face frame unit 1208/1220. The heater/face frame 1208/1220 is supported at the front on the upright supports 1210 and at the rear by a structural spine 1207 which extends between the rear of the foundation 1206 and the rear of the heater unit 1208/1220.

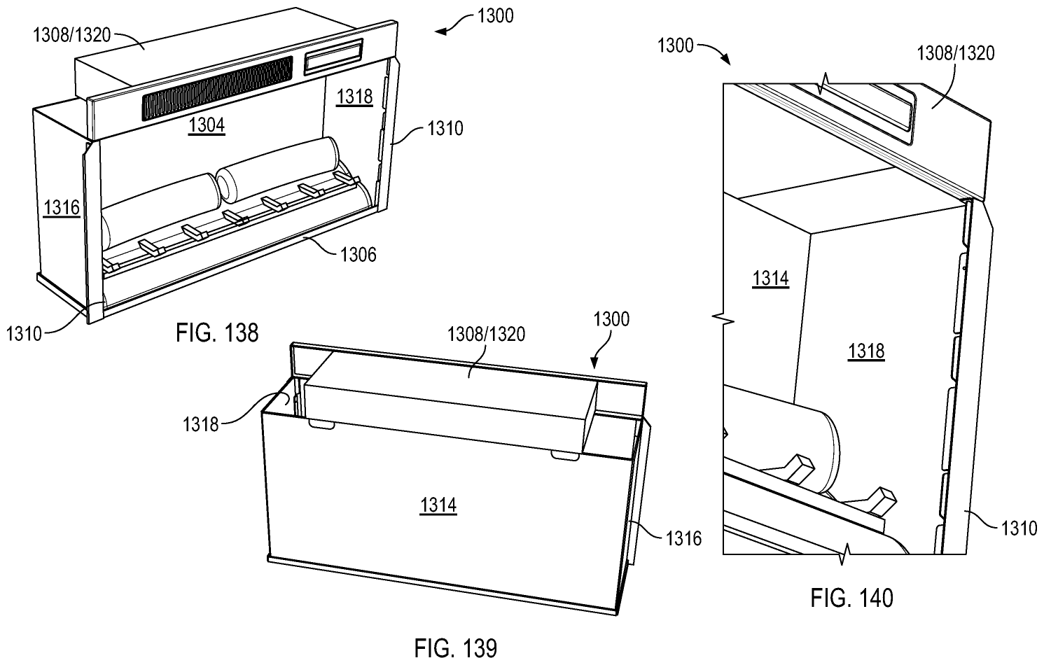

FIGS. 138-140 illustrate another exemplary simulated fireplace insert kit 1300 where the heater/face plate assembly 1308/1320 is again moved to the top of the assembly and is supported at the front on the top ends of the upright structural supports 1310 secured to the foundation 1306 and at the rear by a sheet metal firebox panel 1304 secured to the foundation 1306 and which may also include sheet metal side panels 1316/1318.

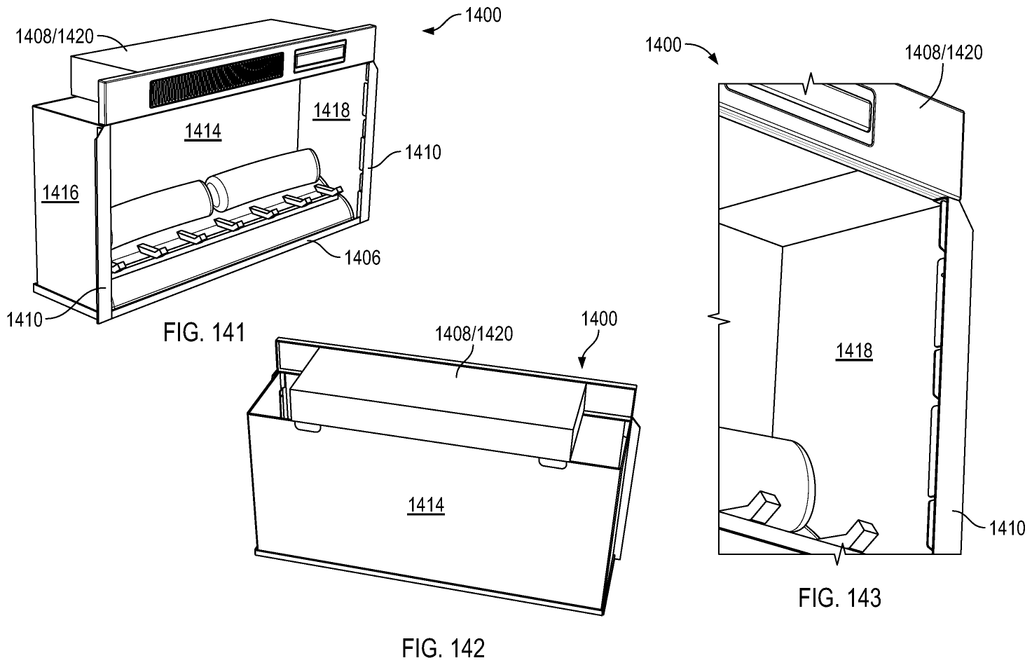

FIGS. 141-143 illustrate still another exemplary simulated fireplace insert kit 1400 where the heater/face plate assembly 1408/1420 is at the top of the kit assembly and is supported at the front on the upright structural supports 1410 secured to the foundation 1406 and at the rear by a rear sheet metal firebox panel 1404 secured to and extending up from the foundation 1406. The assembly may further include MDF side firebox panels 1416/1418.

FIGS. 144-145 illustrate a further exemplary simulated fireplace insert kit 1500 where the heater/face plate assembly 1508/1520 is moved to the top of the assembly and is supported at the front by the top ends of the upright structural supports 1510 secured to the foundation 1506 and at the rear by a sheet metal firebox panel 1504 extending upwardly from the foundation 1506. The present embodiment has no side panels. To the extent that the sides of the firebox are not defined, the interior sidewalls of a corresponding furniture kit may provide complementary firebox illustrations to complete the firebox.

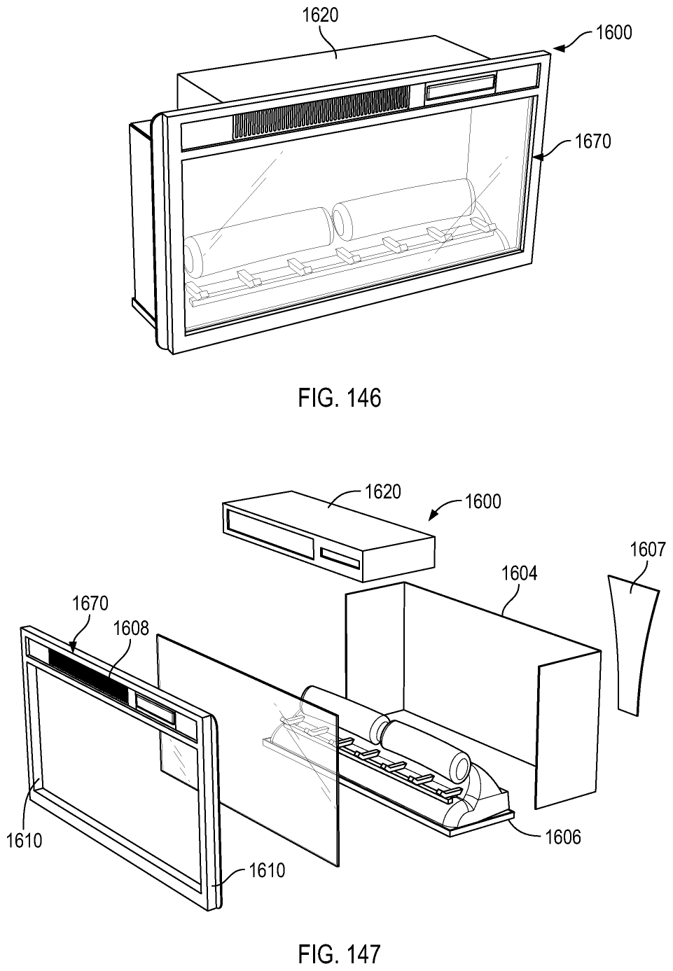

FIGS. 146-147 illustrate an exemplary simulated fireplace insert kit 1600 where the heater assembly 1620 is moved to the top of the assembly and is supported at the front by a full square frame 1670 including the face frame 1608 and upright supports 1610 secured to the foundation 1606 and at the rear by a MDF firebox panel 1604 with a rear structural spine 1607 extending up from the foundation 1606.

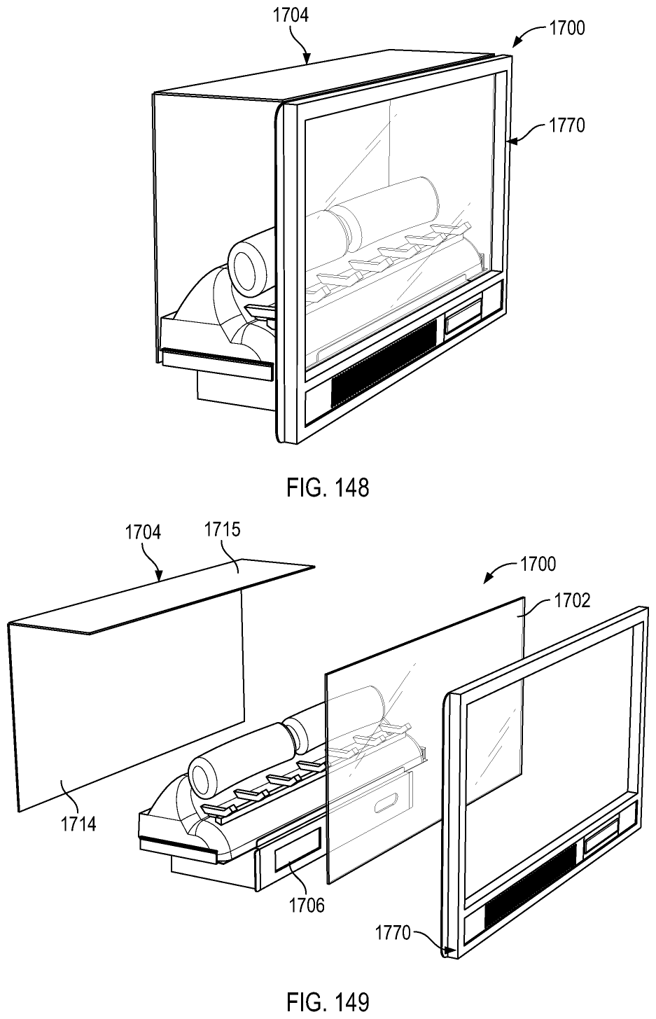

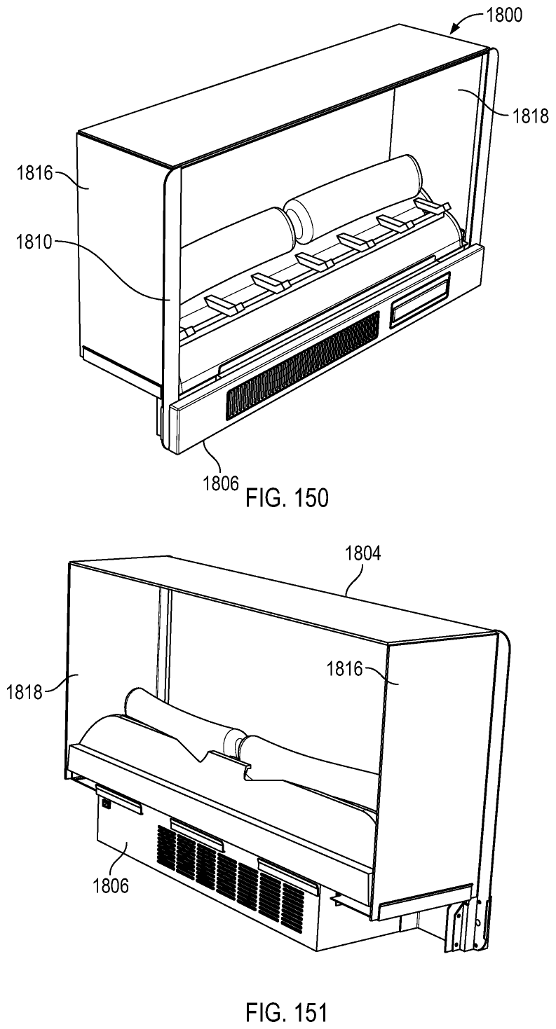

FIGS. 148-149 illustrate an exemplary simulated fireplace insert kit 1700 with the foundation/heater unit 1706 at the bottom, and where the firebox panel 1704 has a rear imaging screen 1714 and a forward extending top portion 1715. The viewing panel 1702 is contained within a fully square face frame 1770 secured to the foundation 1706 and the top forwardly extending portion of the firebox panel 1704 are supported on the face frame 1770. To the extent that the sides of the firebox are not defined, the interior sidewalls of a corresponding furniture kit may provide complementary firebox illustrations to complete the firebox.

FIGS. 150-151 illustrate an exemplary simulated fireplace insert kit 1800 with the foundation/heater unit 1806 at the bottom and where the firebox panel 1804 has a top portion 1815 and downward side portions 1816/1818 and wherein the glass viewing panel 1802 and top portion 1815 are supported within a fully square face frame 1870 secured to the foundation 1806. To the extent that the rear of the firebox is not defined, a rear wall of a corresponding furniture kit may provide complementary firebox illustrations to complete the firebox.

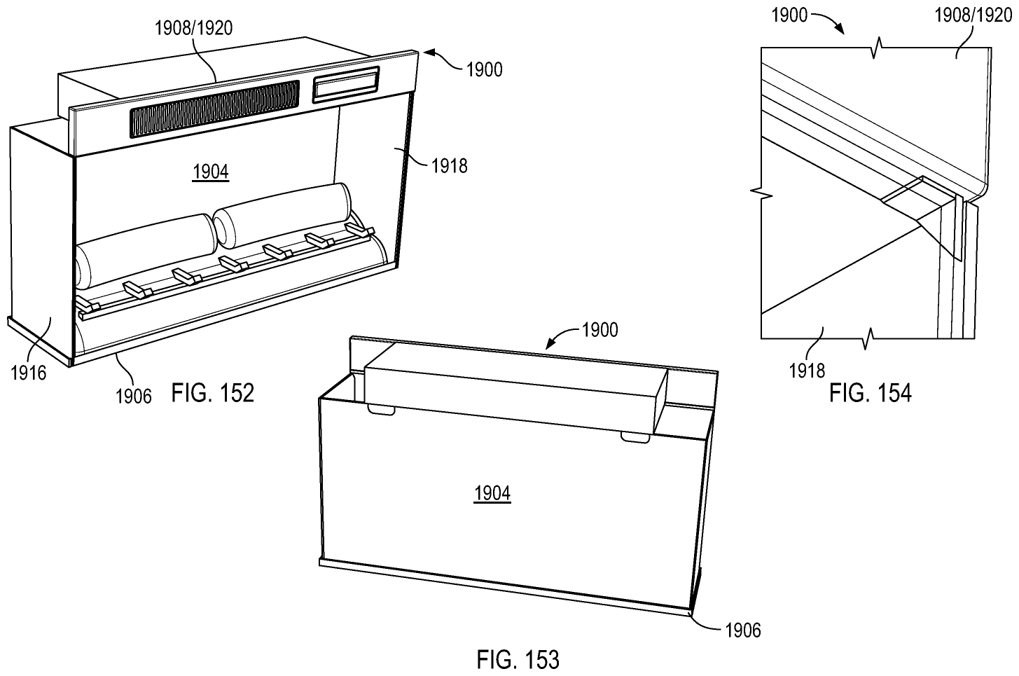

FIGS. 152-154 illustrate an exemplary simulated fireplace insert kit 1900 where the heater/face frame 1908/1920 assembly is moved to the top of the assembly and is fully supported at the rear and sides by a sheet metal firebox panel 1904 which includes sheet metal side panels 1916/1918 but no face frame assembly.

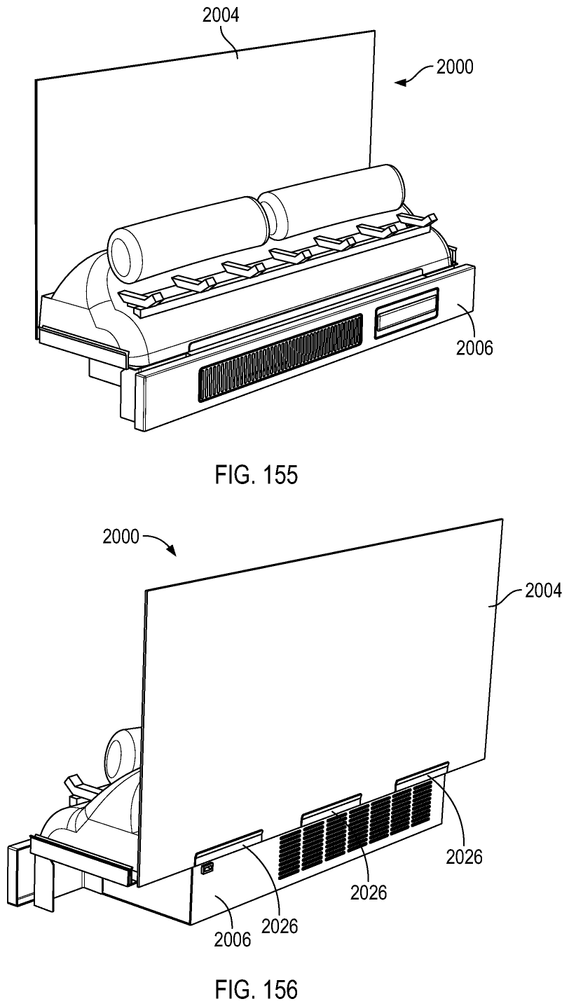

FIGS. 155-156 illustrate an exemplary simulated fireplace insert kit 2000 where the firebox panel 2004 has a rear imaging screen 2014 with no top portion and no side portions and is fully supported by the channel 2026 at the rear of the foundation 2006.

Although the embodiments shown herein illustrate a ready to assemble fireplace insert kit, it would be appreciated by one skilled in the art that the insert kit described herein may be adapted for various other types of furniture pieces, consoles and/or standalone use.

Further, it would be appreciated by those skilled in the art that various changes and modifications can be made to the illustrated embodiments without departing from the spirit of the present invention. All such modifications and changes are intended to be within the scope of the present invention. While the present disclosure provides for various embodiments, it is intended for the subassemblies of the various embodiments to be discrete subassemblies that can be used in the various embodiments interchangeably.

What is claimed:

1. A ready to assemble simulated fireplace insert kit comprising:
a firebox panel having a rear imaging screen portion and a forwardly extending portion;
a foundation having a front, a top, opposing left and right sides, and a rear;
said firebox panel having a lower peripheral edge removably secured to said foundation,
first and second upright structural supports each having a lower end removably secured to said foundation adjacent to said front,
said forwardly extending panel portion of said firebox panel engaging said uprights structural supports whereby said foundation and said upright structural supports transfer structural rigidity to said firebox panel; and
a simulated firebed assembly removably received on the foundation.

2. The ready to assemble simulated fireplace insert kit of claim 1, wherein each of said upright supports has a rearwardly extending firebox panel attachment structure,
said forwardly extending portion of said firebox panel having a respective forward edge portion removably secured to said rearwardly extending firebox panel attachment structures of said upright structural supports.

3. The ready to assemble simulated fireplace insert kit of claim 1, wherein said forwardly extending panel portion comprises left and right side panel portions extending forwardly from side edges of said rear imaging screen portion.

4. The ready to assemble simulated fireplace insert kit of claim 3,
wherein said rearwardly extending firebox panel attachment structures comprise a planar flange extending along at least a portion of said upright supports.

5. The ready to assemble simulated fireplace insert kit of claim 3,
wherein said rearwardly extending firebox panel attachment structures comprise a channel extending along at least a portion of said upright supports.

6. The ready to assemble simulated fireplace insert kit of claim 3,
wherein said left and right side panel portions of said firebox panel each have a lower peripheral edge removably secured to said foundation.

7. The ready to assemble simulated fireplace insert kit of claim 2, wherein said forwardly extending panel portion comprises a top panel portion extending forwardly from a top edge of said rear imaging screen portion

8. The ready to assemble simulated fireplace insert kit of claim 7,
wherein said rearwardly extending firebox panel attachment structures comprise a shoulder extending rearwardly adjacent an upper end of said upright supports.

9. The ready to assemble simulated fireplace insert kit of claim 1,
wherein said forwardly extending panel portion comprises a top panel portion extending forwardly from a top edge of said rear imaging screen portion,
said kit further comprising a firebox panel edge support having a rearwardly extending support structure secured to a forward edge of said top panel portion,

10. The ready to assemble simulated fireplace insert kit of claim 9,
wherein said firebox panel edge support further includes a downwardly extending portion engaging said upright structural supports.

11. The ready to assemble simulated fireplace insert kit of claim 1,
wherein said kit further comprises a heater unit located within the foundation.

12. The ready to assemble simulated fireplace insert kit of claim 1,
wherein said kit further comprises a decorative face frame secured to the front of the foundation.

13. The ready to assemble simulated fireplace insert kit of claim 1,
wherein said kit further comprises a transparent viewing panel removably received and supported at the front of the foundation between said first and second upright supports.

14. The ready to assemble simulated fireplace insert kit of claim 13,
wherein each of said upright structural supports each has an inwardly extending viewing panel attachment structure,
said transparent viewing panel having opposing side edges removably received and coupled to said viewing panel attachment structures.

15. The ready to assemble simulated fireplace insert kit of claim 14,
wherein said transparent viewing panel comprises glass and said viewing panel attachment structures comprise inwardly extending channels.

16. The ready to assemble simulated fireplace insert kit of claim 1,
wherein said kit further comprises a mesh screen panel removably received and supported at the front of the foundation between said left and right upright supports.

17. The ready to assemble simulated fireplace insert kit of claim 1,
wherein said kit further comprises a horizontal structural support extending between upper ends of said first and second upright structural supports.

18. The ready to assemble simulated fireplace insert kit of claim 17,
wherein said horizontal structural support comprises a structural connector removably secured between respective upper ends of said first and second upright structural supports.

19. The ready to assemble simulated fireplace insert kit of claim 2,
wherein said kit further comprises a horizontal structural support extending between upper ends of said first and second upright structural supports.

20. The ready to assemble simulated fireplace insert kit of claim 19,
wherein said horizontal structural support comprises a structural connector removably secured between respective upper ends of said first and second upright structural supports.

21. The ready to assemble simulated fireplace insert kit of claim 3,
wherein said kit further comprises a horizontal structural support extending between upper ends of said first and second upright structural supports.

22. The ready to assemble simulated fireplace insert kit of claim 21,
wherein said horizontal structural support comprises a structural connector removably secured between respective upper ends of said first and second upright structural supports.

23. The ready to assemble simulated fireplace insert kit of claim 9,
said kit further comprising a horizontal structural support extending between upper ends of said first and second upright structural supports.

24. The ready to assemble simulated fireplace insert kit of claim 22,
wherein said horizontal structural support comprises a structural connector removably secured between respective upper ends of said first and second upright structural supports.

25. The ready to assemble simulated fireplace insert kit of claim 1,
wherein said foundation includes an upwardly facing rear channel, said lower peripheral edge of said rear imaging screen of said firebox panel removably received in said rear channel.

26. The ready to assemble simulated fireplace insert kit of claim 4,
wherein said foundation includes left and right upwardly facing side channels, said side panel portions of said firebox panel removably received in said side channels.
